(19) United States
(12) Patent Application Publication
(10) Pub. No.: US 2024/0310504 A1
(43) Pub. Date: Sep. 19, 2024

(54) PRESENCE DETECTION USING UWB RADAR

(71) Applicant: Samsung Electronics Co., Ltd., Suwon-si (KR)

(72) Inventors: Hoang Viet Nguyen, Frisco, TX (US); Yuming Zhu, Plano, TX (US); Guanbo Chen, McKinney, TX (US); Songwei Li, McKinney, TX (US); Qiang Xie, Suwon-si (KR)

(21) Appl. No.: 18/528,547

(22) Filed: Dec. 4, 2023

Related U.S. Application Data
(60) Provisional application No. 63/452,311, filed on Mar. 15, 2023.

(51) Int. Cl. G01S 13/56; G01S 7/41; G01S 13/02

(52) U.S. Cl. CPC G01S 13/56; G01S 7/415; G01S 13/0209

(57) ABSTRACT

A method for presence detection using ultra-wide band (UWB) radar includes obtaining a set of centroids based on UWB radar measurements. The method includes, for each respective centroid among the set of centroids: classifying the respective centroid as one among human movement and non-human movement, based on a set of features for the respective centroid satisfying a human-movement condition; and when the respective centroid is classified as the human movement, determining a two-dimensional (2D) location of human movement based on the UWB radar measurements. The method includes updating a current state value that indicates whether a human presence is detected inside boundaries of a 3D space, based at least in part on the classification of each of the respective centroids among the set of centroids.

### CROSS-REFERENCE TO RELATED APPLICATION(S) AND CLAIM OF PRIORITY

This application claims priority under 35 U.S.C. § 119(e) to U.S. Provisional Patent Application No. 63/452,311 filed on Mar. 15, 2023. The above-identified provisional patent application is hereby incorporated by reference in its entirety.

### TECHNICAL FIELD

This disclosure relates generally to radar systems. More specifically, this disclosure relates to presence detection using ultrawide band radar.

### BACKGROUND

Presence detection is a useful feature in smart home devices. Presence detection provides the basics for other features such as smart control of lighting, heating, ventilation, and air conditioning. This presence detection feature is currently achieved using different modalities, including cameras or infrared (IR) sensors, but each modality has its own disadvantages (e.g., privacy, sensitivity to lighting conditions).

### SUMMARY

This disclosure provides presence detection using ultrawide band (UWB) radar.

In one embodiment, a method for presence detection using UWB radar is provided. The method includes obtaining a set of centroids based on UWB radar measurements. The method includes, for each respective centroid among the set of centroids: classifying the respective centroid as one among human movement and non-human movement, based on a set of features for the respective centroid satisfying a human-movement condition; and when the respective centroid is classified as the human movement, determining a two-dimensional (2D) location of human movement based on the UWB radar measurements. The method includes updating a current state value that indicates whether a human presence is detected inside boundaries of a 3D space, based at least in part on the classification of each of the respective centroids among the set of centroids.

In another embodiment, an electronic device that performs presence detection using UWB radar is provided. The electronic device includes a transceiver having UWB radar capabilities and configured to transmit and receive radar signals. The electronic device includes a processor operably connected to the transceiver. The processor is configured to obtain a set of centroids based on UWB radar measurements. The processor is configured to, for each respective centroid among the set of centroids: classify the respective centroid as one among human movement and non-human movement, based on a set of features for the respective centroid satisfying a human-movement condition; and when the respective centroid is classified as the human movement, determine a two-dimensional (2D) location of human movement based on the UWB radar measurements. The processor is configured to update a current state value that indicates whether a human presence is detected inside boundaries of a 3D space, based at least in part on the classification of each of the respective centroids among the set of centroids.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Definitions for other certain words and phrases may be provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system in accordance with an embodiment of this disclosure;

FIG. 2 illustrates an example electronic device in accordance with an embodiment of this disclosure;

FIG. 3 illustrates a three-dimensional view of an example electronic device that includes multiple ultrawide band (UWB) antenna modules in accordance with an embodiment of this disclosure;

FIG. 4 illustrates an example architecture of a monostatic radar in an electronic device 400 in accordance with an embodiment of this disclosure;

FIG. 5 illustrates an overview of a room-level presence detection algorithm, in accordance with an embodiment of this disclosure;

FIG. 6 illustrates example channel impulse response (CIR) data, in accordance with an embodiment of this disclosure;

FIG. 7 illustrates an example instantaneous human movement detection module, in accordance with an embodiment of this disclosure;

FIG. 8 illustrates an example process flow to compute a range doppler map (RDM) from an input CIR window, in accordance with an embodiment of this disclosure;

FIG. 9 illustrates an example RDM, in accordance with an embodiment of this disclosure;

FIG. 10A illustrates an example cell averaging constant false alarm rate (CA-CFAR) hit map generated based on the RDM of FIG. 9, in accordance with an embodiment of this disclosure;

FIGS. 10B and 10C illustrate additional features that can be extracted from the CIR window, in accordance with an embodiment of this disclosure.

FIG. 11 illustrates an example erosion-type morphological processing, in accordance with an embodiment of this disclosure;

FIG. 12 illustrates an example dilation-type morphological processing, in accordance with an embodiment of this disclosure;

FIG. 13 illustrates n example CA-CFAR hit map generated based on an RDM, in accordance with an embodiment of this disclosure;

FIG. 14 illustrates erosion-dilation filtered CA-CFAR hit map generated by processing the CA-CFAR hit map of FIG. 13 through a CFAR hit map filter of FIG. 7;

FIGS. 15, 16, 17, and 18 illustrate RDM features, spectrogram features, power-weighted Doppler features, bandwidth features, and densities features extracted from the same CIR window, in accordance with an embodiment of this disclosure;

FIG. 19 illustrates an example event handlers module, in accordance with an embodiment of this disclosure;

FIG. 20 illustrates an example human movement coordinates recordation module, in accordance with an embodiment of this disclosure;

FIG. 21 illustrates an example breath detection module, in accordance with an embodiment of this disclosure;

FIG. 22 illustrates an example CIRSUM after clutter removal and low pass filtering is applied, in accordance with an embodiment of this disclosure;

FIG. 23 illustrates an example graph of average energy per range bin, in accordance with an embodiment of this disclosure; and

FIG. 24 illustrates a method for presence detection using UWB radar, in accordance with an embodiment of this disclosure.

### DETAILED DESCRIPTION

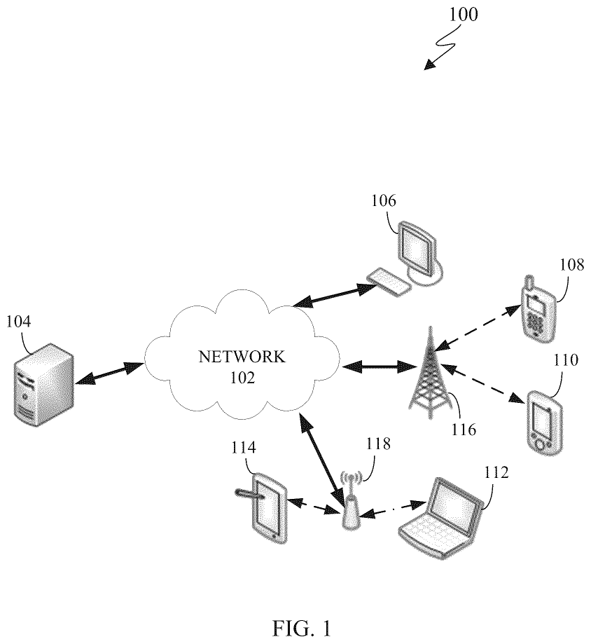

FIGS. 1 through 24, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged wireless communication device.

Ultra-wideband (UWB) technology is being gradually integrated in mobile and consumer products for variety of applications, including device to device localization and indoor localization. The next generation of UWB chips are also equipped with radar capabilities, such that a device that includes the UWB chips can detect movements as well as locations of those movements within the radar's field-of-view (FOV). This disclosure presents methods to utilize an UWB chip equipped with radar capability of to determine the room presence status using a single device.

FIG. 1 illustrates an example communication system in accordance with an embodiment of this disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-114. The client devices 106-114 may be, for example, a smartphone, a tablet computer, a laptop, a personal computer, a wearable device, a head mounted display, or the like. The server 104 can represent one or more servers. Each server 104 includes any suitable computing or processing device that can provide computing services for one or more client devices, such as the client devices 106-114. Each server 104 could, for example, include one or more processing devices, one or more memories storing instructions and data, and one or more network interfaces facilitating communication over the network 102.

Each of the client devices 106-114 represent any suitable computing or processing device that interacts with at least one server (such as the server 104) or other computing device(s) over the network 102. The client devices 106-114 include a desktop computer 106, a mobile telephone or mobile device 108 (such as a smartphone), a PDA 110, a laptop computer 112, and a tablet computer 114. However, any other or additional client devices, such as a hub device, could be used in the communication system 100. Smartphones represent a class of mobile devices 108 that are handheld devices with mobile operating systems and integrated mobile broadband cellular network connections for voice, short message service (SMS), and Internet data communications.

In this example, some client devices 108 and 110-114 communicate indirectly with the network 102. For example, the mobile device 108 and PDA 110 communicate via one or more base stations 116, such as cellular base stations or eNodeBs (eNBs) or gNodeBs (gNBs). Also, the laptop computer 112 and the tablet computer 114 communicate via one or more wireless access points 118, such as IEEE 802.11 wireless access points. Note that these are for illustration only and that each of the client devices 106-114 could communicate directly with the network 102 or indirectly with the network 102 via any suitable intermediate device(s) or network(s). In certain embodiments, any of the client devices 106-114 transmit information securely and efficiently to another device, such as, for example, the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

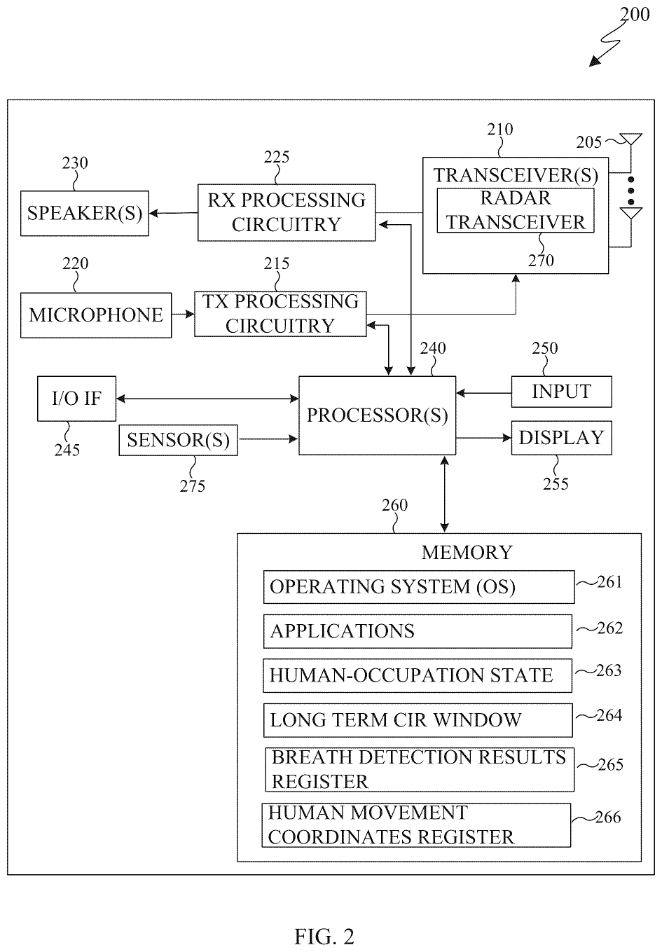

FIG. 2 illustrates an example electronic device in accordance with an embodiment of this disclosure. In particular, FIG. 2 illustrates an example electronic device 200, and the electronic device 200 could represent the server 104 or one or more of the client devices 106-114 in FIG. 1. The electronic device 200 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, or the tablet computer 114 of FIG. 1), a robot, and the like.

As shown in FIG. 2, the electronic device 200 includes transceiver(s) 210, transmit (TX) processing circuitry 215, a microphone 220, and receive (RX) processing circuitry 225. The transceiver(s) 210 can include, for example, a RF transceiver, a BLUETOOTH transceiver, a WiFi transceiver, a ZIGBEE transceiver, an infrared transceiver, and various other wireless communication signals. The electronic device 200 also includes a speaker 230, a processor 240, an input/output (I/O) interface (IF) 245, an input 250, a display 255, a memory 260, and a sensor 275. The memory 260 includes an operating system (OS) 261, and one or more applications 262.

The transceiver(s) 210 can include an antenna array 205 including numerous antennas. The antennas of the antenna array can include a radiating element composed of a conductive material or a conductive pattern formed in or on a substrate. The transceiver(s) 210 transmit and receive a signal or power to or from the electronic device 200. The transceiver(s) 210 receives an incoming signal transmitted from an access point (such as a base station, WiFi router, or BLUETOOTH device) or other device of the network 102 (such as a WiFi, BLUETOOTH, cellular, 5G, 6G, LTE, LTE-A, WiMAX, or any other type of wireless network). The transceiver(s) 210 down-converts the incoming RF signal to generate an intermediate frequency or baseband signal. The intermediate frequency or baseband signal is sent to the RX processing circuitry 225 that generates a processed baseband signal by filtering, decoding, and/or digitizing the baseband or intermediate frequency signal. The RX processing circuitry 225 transmits the processed baseband signal to the speaker 230 (such as for voice data) or to the processor 240 for further processing (such as for web browsing data).

The TX processing circuitry 215 receives analog or digital voice data from the microphone 220 or other outgoing baseband data from the processor 240. The outgoing baseband data can include web data, e-mail, or interactive video game data. The TX processing circuitry 215 encodes, multiplexes, and/or digitizes the outgoing baseband data to generate a processed baseband or intermediate frequency signal. The transceiver(s) 210 receives the outgoing processed baseband or intermediate frequency signal from the TX processing circuitry 215 and up-converts the baseband or intermediate frequency signal to a signal that is transmitted.

The processor 240 can include one or more processors or other processing devices. The processor 240 can execute instructions that are stored in the memory 260, such as the OS 261 in order to control the overall operation of the electronic device 200. For example, the processor 240 could control the reception of downlink (DL) channel signals and the transmission of uplink (UL) channel signals by the transceiver(s) 210, the RX processing circuitry 225, and the TX processing circuitry 215 in accordance with well-known principles. The processor 240 can include any suitable number(s) and type(s) of processors or other devices in any suitable arrangement. For example, in certain embodiments, the processor 240 includes at least one microprocessor or microcontroller. Example types of processor 240 include microprocessors, microcontrollers, digital signal processors, field programmable gate arrays, application specific integrated circuits, and discrete circuitry. In certain embodiments, the processor 240 can include a neural network.

The processor 240 is also capable of executing other processes and programs resident in the memory 260, such as operations that receive and store data. The processor 240 can move data into or out of the memory 260 as required by an executing process. In certain embodiments, the processor 240 is configured to execute the one or more applications 262 based on the OS 261 or in response to signals received from external source(s) or an operator. Example, applications 262 can include a multimedia player (such as a music player or a video player), a phone calling application, a virtual personal assistant, and the like.

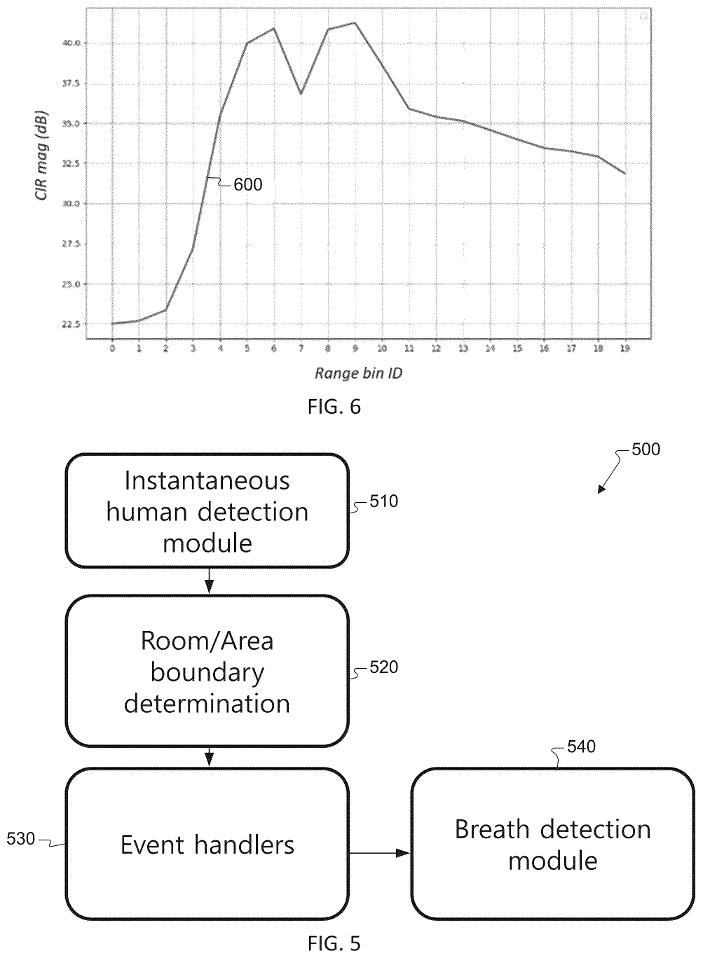

In accordance with embodiments of this disclosure, the applications 262 can include a room-level presence detection system 500 (FIG. 5) that uses UWB radar signals and radar measurements to determine whether a human is present within boundaries of a defined space (e.g., room; moving area), and update a human-occupation state 263 based on this presence detection. The human-occupation state 263 is used for smart control of lighting, HVAC, or other home appliances. The memory 260 includes a long term CIR window 264, a breath detection results register 265, and a human movement coordinates register 266, which are described further below.

The processor 240 is also coupled to the I/O interface 245 that provides the electronic device 200 with the ability to connect to other devices, such as client devices 106-114. The I/O interface 245 is the communication path between these accessories and the processor 240.

The processor 240 is also coupled to the input 250 and the display 255. The operator of the electronic device 200 can use the input 250 to enter data or inputs into the electronic device 200. The input 250 can be a keyboard, touchscreen, mouse, track ball, voice input, or other device capable of acting as a user interface to allow a user in interact with the electronic device 200. For example, the input 250 can include voice recognition processing, thereby allowing a user to input a voice command. In another example, the input 250 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 250 can be associated with the sensor(s) 275, a camera, and the like, which provide additional inputs to the processor 240. The input 250 can also include a control circuit. In the capacitive scheme, the input 250 can recognize touch or proximity.

The display 255 can be a liquid crystal display (LCD), light-emitting diode (LED) display, organic LED (OLED), active-matrix OLED (AMOLED), or other display capable of rendering text and/or graphics, such as from websites, videos, games, images, and the like. The display 255 can be a singular display screen or multiple display screens capable of creating a stereoscopic display. In certain embodiments, the display 255 is a heads-up display (HUD).

The memory 260 is coupled to the processor 240. Part of the memory 260 could include a RAM, and another part of the memory 260 could include a Flash memory or other ROM. The memory 260 can include persistent storage (not shown) that represents any structure(s) capable of storing and facilitating retrieval of information (such as data, program code, and/or other suitable information). The memory 260 can contain one or more components or devices supporting longer-term storage of data, such as a read only memory, hard drive, Flash memory, or optical disc.

The electronic device 200 further includes one or more sensors 275 that can meter a physical quantity or detect an activation state of the electronic device 200 and convert metered or detected information into an electrical signal. For example, the sensor 275 can include one or more buttons for touch input, a camera, a gesture sensor, optical sensors, cameras, one or more inertial measurement units (IMUs), such as a gyroscope or gyro sensor, and an accelerometer. The sensor 275 can also include an air pressure sensor, a magnetic sensor or magnetometer, a grip sensor, a proximity sensor, an ambient light sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 275 can further include control circuits for controlling any of the sensors included therein. Any of these sensor(s) 275 may be located within the electronic device 200 or within a secondary device operably connected to the electronic device 200.

The electronic device 200 as used herein can include a transceiver that can both transmit and receive radar signals. For example, the transceiver(s) 210 includes a radar transceiver 270, as described more particularly below. In this embodiment, one or more transceivers in the transceiver(s) 210 is a radar transceiver 270 that is configured to transmit and receive signals for detecting and ranging purposes. For example, the radar transceiver 270 may be any type of transceiver including, but not limited to a WiFi transceiver, for example, an 802.11ay transceiver. The radar transceiver 270 can operate both radar and communication signals concurrently. The radar transceiver 270 includes two or more antenna arrays, or antenna pairs, that each includes a transmitter (or transmitter antenna) and a receiver (or receiver antenna). The radar transceiver 270 can transmit signals at a various frequencies. For example, the radar transceiver 270 can transmit signals at frequencies including, but not limited to, 6 GHZ, 7 GHZ, 8 GHZ, 28 GHZ, 39 GHz, 60 GHz, and 77 GHz. In some embodiments, the signals transmitted by the radar transceiver 270 can include, but are not limited to, millimeter wave (mmWave) signals, or ultra-wide band (UWB) signals. The radar transceiver 270 can receive the signals, which were originally transmitted from the radar transceiver 270, after the signals have bounced or reflected off of target objects in the surrounding environment of the electronic device 200. In some embodiments, the radar transceiver 270 can be associated with the input 250 to provide additional inputs to the processor 240.

In certain embodiments, the radar transceiver 270 is a monostatic radar. A monostatic radar includes a transmitter of a radar signal and a receiver, which receives a delayed echo of the radar signal, which are positioned at the same or similar location. For example, the transmitter and the receiver can use the same antenna or nearly co-located while using separate, but adjacent antennas. Monostatic radars are assumed coherent such that the transmitter and receiver are synchronized via a common time reference. FIG. 4, below, illustrates an example monostatic radar.

In certain embodiments, the radar transceiver 270 can include a transmitter and a receiver. In the radar transceiver 270, the transmitter of can transmit UWB signals. In the radar transceiver 270, the receiver can receive the UWB signals originally transmitted from the transmitter after the UWB signals have bounced or reflected off of target objects in the surrounding environment of the electronic device 200. The processor 240 can analyze the time difference between when the UWB signals are transmitted and received to measure the distance of the target objects from the electronic device 200.

Although FIG. 2 illustrates one example of electronic device 200, various changes can be made to FIG. 2. For example, various components in FIG. 2 can be combined, further subdivided, or omitted and additional components can be added according to particular needs. As a particular example, the processor 240 can be divided into multiple processors, such as one or more central processing units (CPUs), one or more graphics processing units (GPUs), one or more neural networks, and the like. Also, while FIG. 2 illustrates the electronic device 200 configured as a mobile telephone, tablet, or smartphone, the electronic device 200 can be configured to operate as other types of mobile or stationary devices.

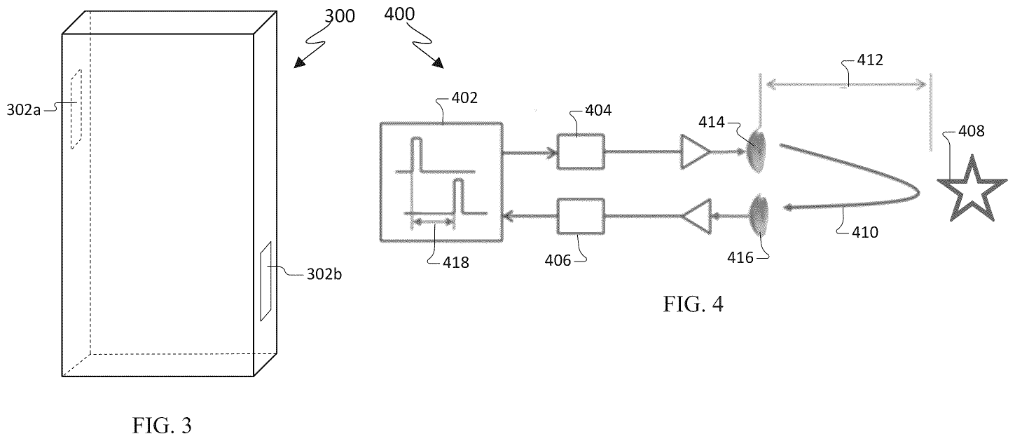

FIG. 3 illustrates a three-dimensional view of an example electronic device 300 that includes UWB antenna modules 302 in accordance with an embodiment of this disclosure. The electronic device 300 could represent one or more of the client devices 106-114 in FIG. 1 or the electronic device 200 in FIG. 2. The embodiments of the electronic device 300 illustrated in FIG. 3 are for illustration only, and other embodiments can be used without departing from the scope of the present disclosure.

As used herein, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

The first antenna module 302a and the second antenna module 302b are positioned at the left and the right edges of the electronic device 300. For simplicity, the first and second antenna modules 302a-302b are generally referred to as an antenna module 302. In certain embodiments, the antenna module 302 includes an antenna panel, circuitry that connects the antenna panel to a processor (such as the processor 240 of FIG. 2), and the processor.

The electronic device 300 can be equipped with multiple antenna elements. For example, the first and second antenna modules 302a-302b are disposed in the electronic device 300 where each antenna module 302 includes one or more antenna elements. The electronic device 300 uses the antenna module 302 to perform beamforming when the electronic device 300 attempts to establish a connection with a base station (for example, base station 116).

FIG. 4 illustrates an example architecture of a monostatic radar in an electronic device 400 in accordance with an embodiment of this disclosure. The embodiments of the architecture of the monostatic radar illustrated in FIG. 4 are for illustration only and other embodiments can be used without departing from the scope of the present disclosure.

The electronic device 400 that includes a processor 402, a transmitter 404, and a receiver 406. The electronic device 400 can be similar to any of the client devices 106-114 of FIG. 1, the electronic device 200 of FIG. 2, or the electronic device 300 of FIG. 3. The processor 402 is similar to the processor 240 of FIG. 2. Additionally, the transmitter 404 and the receiver 406 can be included within the radar transceiver 270 of FIG. 2. The radar can be used to detect the range, velocity and/or angle of a target object 408. Operating at UWB frequency, the radar can be useful for applications such as proximity sensing, gesture recognition, liveness or breath detection, UWB blockage detection, and so on.

The transmitter 404 transmits a signal 410 (for example, a monostatic radar signal) to the target object 408. The target object 408 is located a distance 412 from the electronic device 400. In certain embodiments, the target object 408 corresponds to the objects that form the physical environment around the electronic device 400. For example, the transmitter 404 transmits a signal 410 via a transmit antenna 414. The signal 410 reflects off of the target object 408 and is received by the receiver 406 as a delayed echo, via a receive antenna 416. The signal 410 represents one or many signals that can be transmitted from the transmitter 404 and reflected off of the target object 408. The processor 402 can identify the information associated with the target object 408 based on the receiver 406 receiving the multiple reflections of the signals.

The processor 402 analyzes a time difference 418 from when the signal 410 is transmitted by the transmitter 404 and received by the receiver 406. The time difference 418 is also referred to as a delay, which indicates a delay between the transmitter 404 transmitting the signal 410 and the receiver 406 receiving the signal after the signal is reflected or bounced off of the target object 408. Based on the time difference 418, the processor 402 derives the distance 412 between the electronic device 400, and the target object 408. The distance 412 can change when the target object 408 moves while electronic device 400 is stationary. The distance 412 can change when the electronic device 400 moves while the target object 408 is stationary. Also, the distance 412 can change when the electronic device 400 and the target object 408 are both moving.

Although only UWB radar antenna pair 414 and 416 is shown in FIG. 4, it is understood that the RX antenna 416 includes at least two RX antennas that are next to each other and parallel to or coplanar with a plane (for example, that this the room's floor) inside boundaries of a defined space (e.g., moving area). Analogously, the TX antenna 414 can include at least two TX antennas that are next to each other and parallel to or coplanar with the same plane as the RX antennas.

FIG. 5 illustrates an overview of a room-level presence detection system 500, in accordance with an embodiment of this disclosure. The embodiment of the room-level presence detection system 500 shown in FIG. 5 is for illustration only, and other embodiments could be used without departing from the scope of this disclosure. The room-level presence detection system 500 can be or can include an algorithm executed by an electronic device that includes a transceiver configured to transmit and receive UWB radar signals, such as any of the client devices 106-114 of FIG. 1, the electronic device 200 that includes radar transceiver 270 of FIG. 2, the electronic device 300 that includes multiple antenna modules 302a-302b, and the electronic device 400 that includes the architecture of a monostatic radar of FIG. 4. In other words, room-level presence detection system 500 can be an algorithm executed by an electronic device that includes a UWB module (also referred to as UWB radar transceiver). A UWB module includes a UWB chip and associated antennas. In some embodiments, a UWB module is embedded inside a hub device. An example hub device includes a smart home device, such as a smart speaker or a charger hub device.

The room-level presence detection system 500 includes multiple sub-algorithms, which are referred to as modules. In this particular example, the room-level presence detection system 500 includes an instantaneous human detection module 510, a room boundary determination module 520, event handlers module 530, and a breath detection module 540. These modules 510, 520, 530, 540 process UWB radar measurements that the UWB module generates. In this disclosure, the human movement detection module 510 can also be referred to as human movement detector (HMD) 510. In this disclosure, the event handlers module 530 includes an event handler triggered to operate when occurrence of a human movement is detected, and a different event handler triggered to operate when a human movement is not detected.

The hub device that includes the UWB module and that executes the room-level presence detection system 500 can be located in and operate in a room. The UWB module is able to detect motions and positions of the detected motions inside an area, which area is defined by the maximum detectable range and field of view (FOV) of the UWB module. This functionality of the UWB module enables the room-level presence detection system 500 to detect whether a room is unoccupied (i.e., no person inside the room; room status is EMPTY) or occupied (i.e., at least one person inside the room; room status is PRESENCE). This occupied/unoccupied state is also referred to as the human-occupation state, or as the PRESENCE/EMPTY room status. A human-occupation state is a parameter that stores a first value representing the unoccupied state or stores a second value representing the occupied state. When a person is detected inside the room, there are a few challenges to achieve this technique of occupied/unoccupied state detection for a defined area (such as a room) where human movement can occur, as described further below.

A first challenge is to avoid false detections of human presence, such as when the occupied state is falsely detected. Particularly, if the occupied/unoccupied state of a room was based on detected motions alone, the hub device would have many false detections because motion can come from not only human activities (e.g., human walking, sitting, exercising, etc.), but also can come from home appliances and pets (e.g., dogs, cats, etc.). Examples of motion from a home appliance includes fan oscillation, fan blade rotation, and navigation of cleaning robots that sweep, vacuum, or mop. In the room-level presence detection system 500, the HMD 510 incorporates techniques to address this first challenge, which techniques are described further below.

A second challenge is to avoid false detections of room emptiness (i.e., unoccupied state is falsely detected). Particularly, in some cases, even though a person is present and staying within the room, the person can stay still with no motions or few motions, such as when the person is sleeping or watching a movie on a couch. A presence detection system that is purely based on instantaneous motion detections would create unnecessary flickers, resulting in bad user experience, and in some cases can also be harmful. The unnecessary flickers include human-occupation state quickly switching between unoccupied and occupied. As an automated response to the unnecessary flickers, the bad user experience includes light continuously turned on and off in the room. As another example, the unnecessary flickers can control another automated response that is harmful, such as an HVAC system being switched on and off. In the room-level presence detection system 500, each of the event handlers module 530 and the breath detection module 540 incorporates techniques to address this second challenge, which techniques are described further below.

A third challenge is to define a physical space that the hub device (e.g., presence detection system) distinguishes from the coverage area of the hub device. The coverage of the hub device usually is not substantially the same as the physical space of the room or the desired area to be monitored. More particularly, a motion detected within the hub device's coverage area might not be within the desired area/room, so a person moving outside the desired area/room can also trigger the hub device's motion detection. This detection of motion outside the boundaries of the desired monitoring area can also cause undesired user experience, for example, the light in a room is turned on when the person is staying (e.g., located) inside the adjacent room. In the room-level presence detection system 500, each of the HMD 510 and the room boundary determination module 520 incorporates techniques to address this third challenge, which techniques are described further below.

As a solution to the above-described challenges, the electronic device according to embodiments of this disclosure is equipped with a UWB radar module and at least two RX antennas (for example, two RX antennas and one TX antenna; or two TX-RX antenna pairs) and executes the room-level presence detection system 500. The UWB radar module can transmit a high-bandwidth pulse, receive the signal reflected back from an object, and computes the channel impulse response (CIR), which is a signature of the surrounding environment. The movements within the coverage area of the UWB radar module can be displayed in a range doppler map (RDM) of the measurements sensed by the UWB radar module, in terms of position and velocity.

As a solution to the above-described first challenge, the room-level presence detection system 500 includes a two-part determination, first including a classifier that discriminates between human and non-human movements based on a set of features for respective centroids, and secondly, once classified as human movement, a two-dimensional (2D) location of the human movement is determined based on the UWB signals. The two-dimensional (2D) location of the human movement are in the form of Cartesian coordinates (e.g., x,y coordinates) on a map of the coverage area of the UWB radar module. For example, the HMD 510 can perform this two-part determination. For each moving target (such as the target 408 of FIG. 4) detected by the UWB radar, a radar spectrogram is calculated and a set of features for respective centroids are extracted from this radar spectrogram. For each respective centroid, this set of features is then input into a classification algorithm to determine the category of movements, such as human movements, pet movements, and other movements. This classification algorithm avoids false detections caused by non-human movements, and provides the building blocks to a subsequent room status determination.

The UWB radar module, with two RX antennas placed next to each other in a horizontal plane (for example, in the case of two RX antennas and one TX antenna; or two TX-RX antenna pairs), is capable of determining the range (e.g., 412 of FIG. 4) and angle-of-arrival of a movement (e.g., target 408 exhibiting movement). Also, the 2D position of the movement inside the room/area to be monitored can also be determined. That is, the room-level presence detection system 500 enables the hub device to keep track of the last measured position (e.g., 2D position) of a target object that is human, and with the last position of the moving target being known (due to the tracking), the breathing detection module 540 can focus on the area surrounding this last measured position of the movement. As a technical advantage, the electronic device according to embodiments of this disclosure uses two RX antennas of the UWB radar and a steering vector (e.g., in Equation 11) to boost the receiving signal to detect breathing even when that target 408 is at distance as far as 4-5 meters from the UWB radar. When an electronic device includes only one TX-RX antenna pair (or utilizes only one antenna pair), breathing can only be detected when the target 408 is at distance up to 1-2 meters from the UWB radar.

As a solution to the third challenge, the room boundary determination module 520 determines the boundary of the room/area to be monitored, and the HMD 510 obtains the determined boundary from the room boundary determination module 520. To make sure only movements within the room/area to be monitored are accepted into the system 500, that boundary of the room/area to be monitored is compared to the 2D location of the human movement determined by the HMD 510. The hub device (e.g., 200 of FIG. 2) according to embodiments of this disclosure can learn the boundary of the physical room or zone boundary through different ways: (i) an active calibration stage performed by the user; (ii) an adaptive learning process when a history of movements are recorded and the user is sometimes prompted (asked) by the hub device to indicate whether a detection is within the room/area boundary or outside the boundary.

In first embodiment of the room boundary determination module 520, the active calibration stage occurs during the pre-use setup phase, during which the hub device requests the user to walk around the boundary of the room/area while the hub device records all the movements. Once the user is finished walking around the boundary of the room/area, the hub device collects all coordinates of the points along the room/area boundary to define the room/area perimeter.

In a second embodiment of the room boundary determination module 520, the hub device gradually learns the boundary of the room/zone based on user feedback. At first, all movements within the coverage area of the hub device's UWB radar are accepted as movements in the room. During usage, the user can actively disable a wrong movement detection in the case the user moves outside the room/area but is still within the coverage area of the UWB radar.

In a third embodiment of the room boundary determination module 520, the hub device can occasionally query the user, asking the user to input feedback indicating whether the user is located inside the boundaries of the room/area. In the second and third embodiments, these additional inputs of user feedback can be used by the hub device to gradually adjust the acceptable area of human movements to be closer to boundaries of the physical space of the room or the desired area.

As a solution to the second challenge, a detected breathing signal is verified as part of the room-level presence detection system 500. Particularly, a detected breathing signal is verified by analyzing the most recent human movement location (e.g., obtained from HMD 510), thereby reducing false detections and saving resources. Whenever no motion is detected by the UWB radar, the CIR data (e.g., CIR data 600 of FIG. 6) is accumulated into a long buffer called long term CIR window (264 of FIG. 2). When the long term CIR window has accumulated sufficient data, this accumulated CIR data in the long buffer is analyzed to determine whether a human breathing signal is detected within the accumulated data. The 2D location of a breathing signal, if detected, is compared with a last recorded human movement position in order to improve the reliability of the breath detection. The human-occupation state remains as the occupied state if the breathing signal is verified, even when the UWB Radar detects no movement in the room.

FIG. 6 illustrates example channel impulse response (CIR) data 600, in accordance with an embodiment of this disclosure. The embodiment of the CIR data 600 shown in the graph in FIG. 6 is for illustration only, and other embodiments could be used without departing from the scope of this disclosure. In the graph shown, the CIR data 600 includes CIR magnitude at one slow time index at each range bin. The y-axis represents the CIR magnitude as measured in decibels (dB), for example, ranging from 22.5 to greater than 40.0. The x-axis represents the range bin identifier (ID), for example, ranging from 0 to 19. Each range bin ID corresponds to a different range (e.g., distance 412 of FIG. 4) from the UWB radar.

In an IR-UWB radar system, UWB pulse (for example, the signal 410 of FIG. 4) is transmitted from a transmitter (TX) antenna, scattered by objects (such as, target object 408 of FIG. 4) in the environment, and received on a receiver (RX) antenna. The strength or magnitude of the received signal (e.g., received by RX antenna 416 of FIG. 4) is typically dependent on the relative size of the object and the range of the object, which is the distance from the antennas (such as, TX and RX antennas 414 and 416 of FIG. 4) to the location of the object.

The firmware of the UWB radar module estimates the channel impulse response (CIR), namely by executing channel estimation methods. The raw CIR can be denoted by Equation 1, where h[n, m] denotes the CIR for the n^{th} slow time index and m^{th} range bin on the RX antenna, and where Nᵣ denotes the number of range bins.

$$h [ n , m ] ( m = 1 , 2 , … , {N}_{r} ) \qquad ( 1 )$$

The example CIR data 600 of FIG. 6 is obtained from a UWB module that includes one TX-RX antenna pair. Having one antenna pair, a UWB module can determine the range from the radar to a moving target, but the UWB module cannot determine the angle-of-arrival of this target due to not having at least two TX-RX antenna pairs.

To determine such angle-of-arrival, the UWB module requires at least two RX antennas placed next to each other in the same plane as the moving area of the target, and this architecture is used to determine whether a movement happens within a room. In other words, one TX antenna and two RX antennas are able to determine both range and AOA. For ease of explanation, examples in this disclosure refer to a setup scenario having the following characteristics: most movements of a human in a room are movements that occur in the horizontal plane defined by the floor of the room (or in a parallel plane relative to that same room floor); and the two RX antennas of the UWB module are also placed in the same horizontal plane as the room floor (or the plane that is parallel to the room floor). The hub device housing the UWB module could be located in the corner or edge of the room such that range only (e.g., measurement by radar) is not sufficient for determining whether a location of movement is within the room. However, when both range and angle-of-arrival are measured by the radar, the 2D position of the movement can be compared with the space within the room boundary to determine whether the location of the human movement is inside the room boundary our outside the room boundary, and to more correctly indicate the status as in-room or out-of-room. The angle-of-arrival of the reflected signal, which corresponds to reflections from the target movements, can be determined by comparing the phases of the received signal at the two RX antennas.

The embodiments of the disclosure are not limited to 2D location tracking. In some embodiments of this disclosure, the system that implements the room-level presence detection system 500 of FIG. 5 can be extended (e.g., further configured) to track movements of the target object in 3D space by utilizing an additional antenna (e.g., third antenna pair) in the vertical dimension. Tracking movements of the target in the 3D space includes tracking both when a person moves within the horizontal plane (e.g., same as room floor) and when the person moves nonparallel to the horizontal plane, such as when the person ascends and/or descends a stair. In both cases of 2D space or 3D space, the capability to determine both range and angle-of-arrival of moving targets is exploited in room-level presence detection system 500 of FIG. 5.

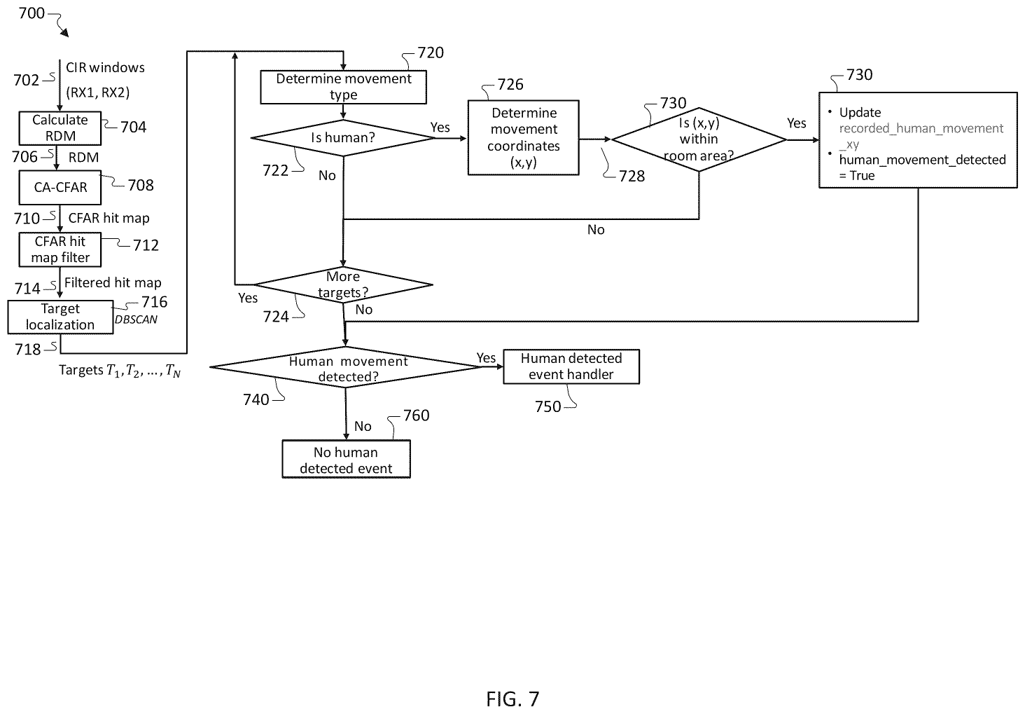

FIG. 7 illustrates an example instantaneous human movement detection module 700, in accordance with an embodiment of this disclosure. The embodiment of the HMD 700 shown in FIG. 7 is for illustration only, and other embodiments could be used without departing from the scope of this disclosure. The instantaneous human movement detection module 700 of FIG. 7 is the same as the HMD 510 of FIG. 5 and can be referred to as HMD 700.

The HMD 700 reduces false detections caused by motions other than human movements. Also, HMD 700 calculates positions of the human movements, and determines in-room/out-of-room status by comparing the positions calculated to a physical room boundary.

The HMD 700 operates on a moving window basis. That is, at each time, the most recent CIR windows 702 incoming from the two TX-RX antenna pairs are formed and input into a processing pipeline. A CIR ID is assigned to the CIR windows 702. The CIR windows 702 include a first CIR window corresponding to a first RX antenna RX1, and a second CIR window corresponding to a second RX antenna RX2 located in the same horizontal plane as RX1. The CIR windows 702 are concurrently captured during and thus correspond to the same time window. The human-occupation state of the room for this current time window is updated at the end of the processing, such as at blocks 750 and 760. The CIR window size is a design parameter that can be chosen to be long enough to capture human movements. For example, in the case of a UWB module with a 200 Hz sampling rate, the window size can be 256 samples, making the window length approximately 1 second. Note that the window size is typically chosen to be a power of 2 for faster Fourier transform implementation.

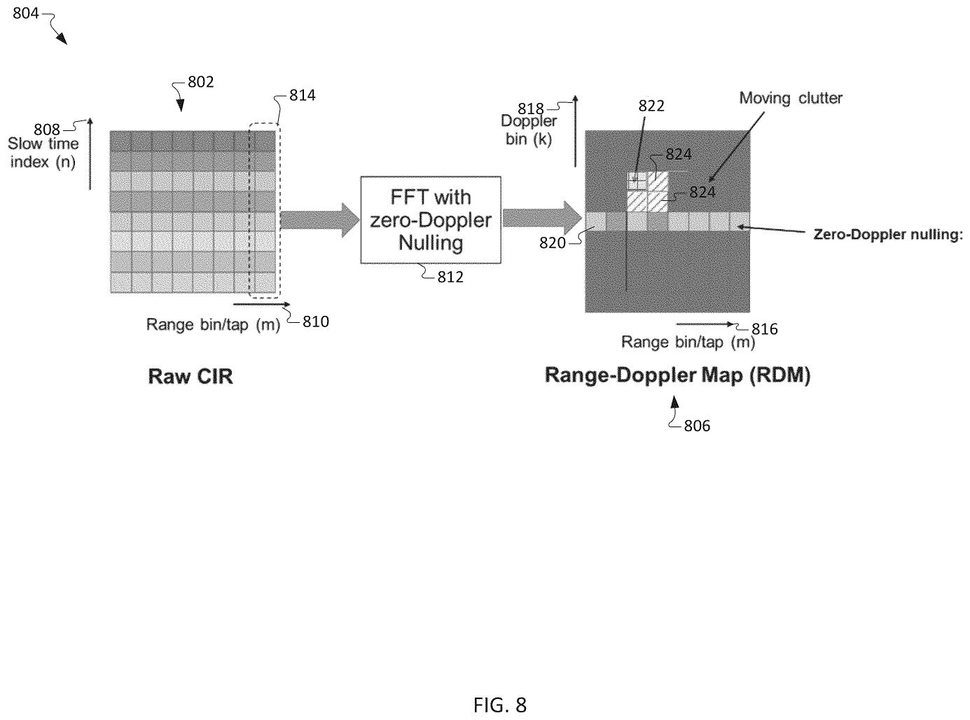

The processing pipeline of HMD 700 can begin at block 704. At block 704, a range doppler map (RDM) 706 is calculated from the input CIR window 702. This calculation of the RDM 706 is described further below with FIG. 8. In this disclosure, RDM 706 is an array in which each element is referred to as a cell.

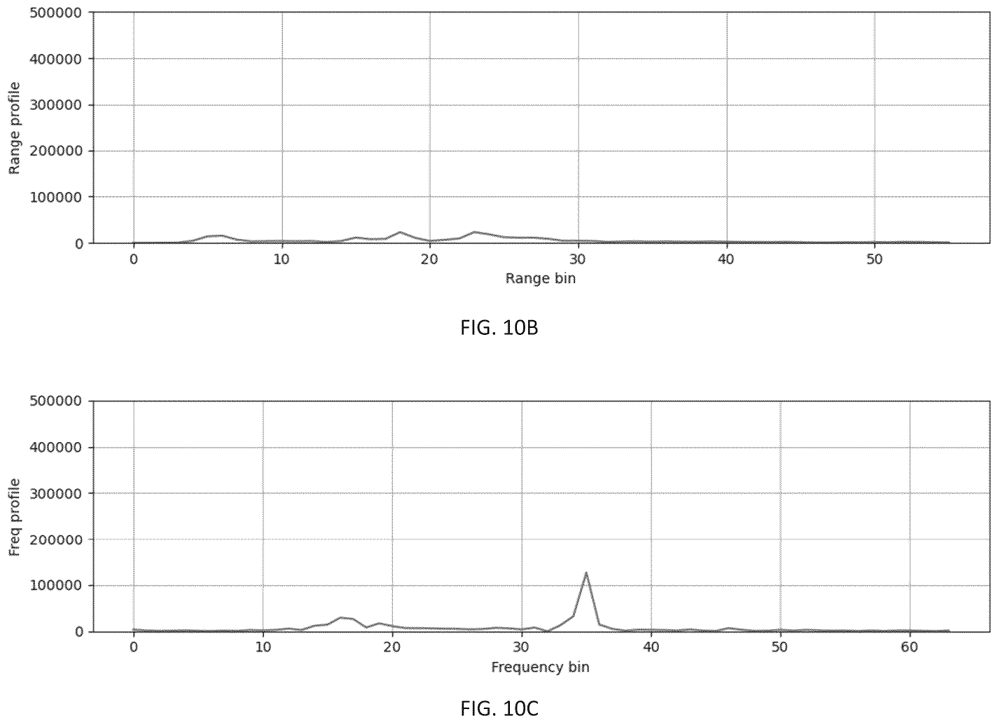

At block 708, cell averaging constant false alarm rate (CA-CFAR) hit map 710 is generated based on the RDM 706. This process of generating the CA-CFAR hit map 710 is described further below with FIG. 10A.

At block 712, the CA-CFAR hit map 710 is filtered through a CFAR hit map filter, thereby generated a filtered hit map 714. The filtered hit map 714 is processed through a target localization algorithm 716. The target localization algorithm can include a clustering algorithm such as DBSCAN. The target localization algorithm identifies a set of target objects 718, for example, {T₁, T₂, . . . . T_{N}}. The set of targets 718 is also referred to the set of centroids. Among the set of target objects 718, each target is indexed from 1 to N.

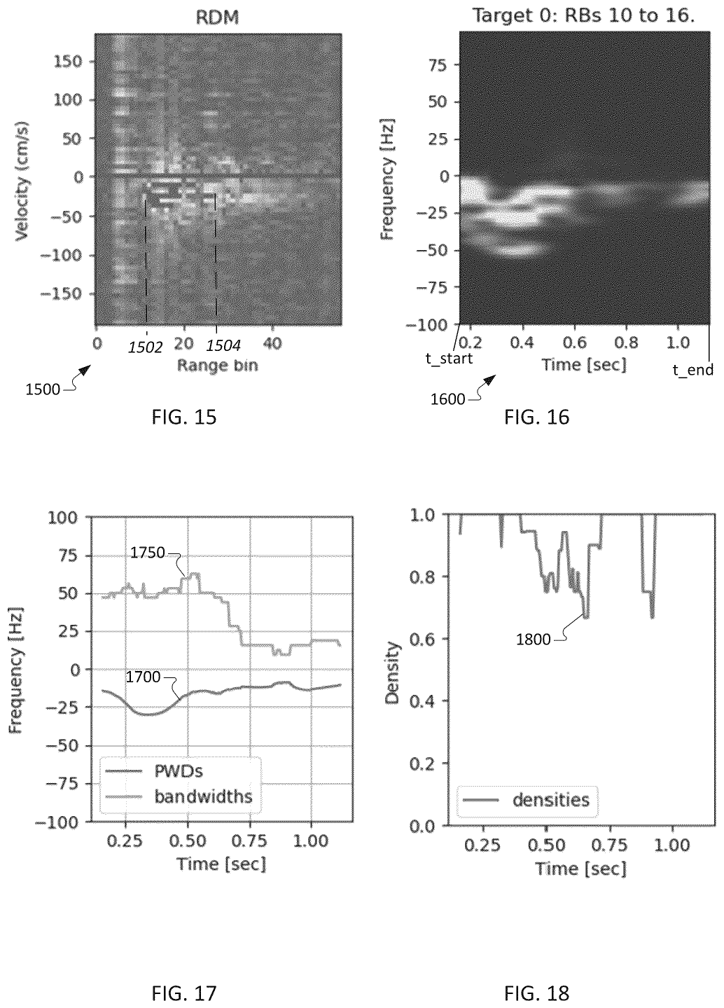

Each target among the set of target objects 718 is processed through block 720, to determine the movement type of the target. The movement type of a target is a classification such that the movement type is either classified as human movement or classified as non-human movement. At block 722, if the movement type of the target is classified as non-human movement, then the processing pipeline proceeds to block 724. At block 724, if the HMD 700 determines that the set of targets 718 includes one or more targets that have not been processed through blocks 720 and 722, then as part of a processing loop (also referred to as centroid loop), the next unprocessed target among the set of targets 718 is processed through blocks 720 and 722. On the other hand, if the movement type of the target is classified as human movement, then the processing pipeline proceeds to block 726. This process of determining the movement type of is described further below with FIGS. 15-18.

At block 726, the location of the target (also referred to as the location of the human movement) is determined. For example, location 728 of the movement can be 2D coordinates such as (x,y), or can be 3D coordinates such as (x, y, z). The 2D coordinates are calculated based on range measurement and angle of arrival estimation.

At block 730, the location of the movement is compared to the boundaries of a defined space (such as the boundaries of a room, or boundaries of a moving area) to determine whether the location 728 of the movement is inside the room. If the location 728 of the movement is outside of the room, the processing pipeline proceeds to block 724.

At block 730, in response to a determination that the location 728 of the movement is inside the room, the location 728 of the movement is recorded as a parameter (recorded_human_movement_xy), and a human_movement_detected flag is set to TRUE. The recorded_human_movement_xy parameter stores the latest, most recent coordinates, and is updated by the recordation of the location 728 of the human movement. For each target among the set of targets 718, the human_movement_detected flag is set to a default value of FALSE until the determination that the location 728 of the human target is inside the room. The processing pipeline proceeds from block 730 to block 740, thereby breaking out from the centroid loop portion (blocks from 724 back to block 720) of the algorithm. In some embodiments, breaking out of the centroid before all N of the centroids in the set of targets 718 have been processed through blocks 720-722 skips (e.g., stops) the remaining unprocessed centroids among the set of targets 718 from being processed through blocks 720-722, thereby less than the entirety of the set of targets 718 get processed through the centroid loop.

At block 740, an event handler is selected, and the HMD 700 outputs a flag human_movement_detected. Based on the value of the flag human_movement_detected after the centroid loop ended (either after breaking from the centroid loop, or after all centroids in the set of targets 718 are processed), different event handlers are called: human-detected event handler 750, or no-human-detected event handler 760. More particularly, a human-detected event handler 750 is selected based on a determination that the set of targets 718 includes at least one target that corresponds to a flag human_movement_detected set to TRUE. Alternatively, a no-human-detected event handler 760 is selected based on a determination that the set of targets 718 does not include any target that corresponds to a flag human_movement_detected set to TRUE. In other words, the no-human-detected event handler 760 is selected based on a determination that all among the set of targets 718 have a flag human_movement_detected set to FALSE.

FIG. 8 illustrates an example process flow to compute a RDM from an input CIR window, in accordance with an embodiment of this disclosure. The CIR window 702 received as input in FIG. 7 can be represented by CIR window 802 shown in FIG. 8. The process flow 804 shown in FIG. 8 provides details about the procedure performed at block 704 of FIG. 7. The RDM 706 of FIG. 7 can be represented by the RDM 806 shown in FIG. 8. The embodiment of the CIR window 802 processed into the RDM 806 shown in FIG. 8 are for illustration only, and other embodiments could be used without departing from the scope of this disclosure.

It is understood that this process flow to compute the RDM 806 is performed for both CIR windows received from the first and second RX antennas RX1 and RX2, so to avoid duplicative descriptions, the process flow shown in FIG. 8 will be described so as to compute the RDM 806 from the CIR window 802 included in the input CIR window received from the first RX antenna RX1.

The CIR window 802 can be raw CIR data for a window of time (for example, a few seconds such as 3-4 seconds). The CIR window 802 is represented as a 2D array in which the time dimension 808 includes this window of time, divided into a number of subblocks of times that are indexed by slow time indices (n). This 2D array includes a range bin dimension 810, which is similar to the range bin dimension shown as the x-axis of the CIR data 600 of FIG. 6. That is, the CIR window 802 includes m rows and n columns such that each row corresponds to a slow time index (using the index n), and each column corresponds to a tap (using the index m). A tap is also referred to as a range bin, which represents a distance measured from the radar. The time dimension arrow shows that the slow time indices (n) increase from bottom to top of the array. The range bin arrow shows that the range bin indices (m) increase from left to right. As an example, the first row of the CIR window 802 can represent 0 to 100 nanoseconds, the second row of the CIR window 802 can represent 101-200 nano seconds, and rows of time continue stacking until the CIR window 802 is full.

At block 812, a Fourier transform (FT) is applied across the time dimension 808 of the CIR window. Particularly, the FT is applied to across each column of the CIR window 802 to obtain a corresponding column of the RDM 806. For example, a FFT applied to the m-th column 814 of the CIR window 802 to calculate the m-th column of the RDM 806. The RDM 806 is a 2D map in which one dimension is the range bin dimension 816 (i.e., distance from the hub device's radar to the target), and the other dimension is the Doppler frequency dimension 818 (i.e., target's velocity).

Embodiments of this disclosure are not limited to applying the FT, and other variations of the FT include a Fast Fourier transform (FFT), or an FFT with zero-Doppler nulling. That is, in some embodiments, the input CIR window 802 of size NFFT is converted to the RDM 806 by applying the FFT across the slow-time index n as shown in Equation 2.

$$RDM [ k , m ] = {Σ}_{p = 0}^{{N}_{FFT} - 1} h [ p , m ] {e}^{- \frac{j 2 π pk}{{N}_{FFT}}} \qquad ( 2 )$$

$$for$$

$$k ∈ 𝒦 = \{ - \frac{{N}_{FFT}}{2} , \frac{{N}_{FFT}}{2} - 1 , … , \frac{{N}_{FFT}}{2} - 2 , \frac{{N}_{FFT}}{2} - 1 \}$$

According to the zero-Doppler nulling, the zero-frequency component of the RDM is set to 0 (zero-nulling) in order to remove the non-moving clutter components. That is, any Doppler bin corresponding to a zero-velocity is set equal to a zero value, thereby objects that are stationary to be ignored. In this example, the RDM 806 includes an entire row 820 nulled to the zero value, cells 822-824 that represent a potential target. The cells 822-824 that represent a potential target are not (moving or non-moving) clutter components. Among the cells 822-824 that represent a potential target, a moving target cell 822 has an energy level that is higher than the potential target cells 824, and more likely represents the moving target. Each cell of the RDM 806 that represents a potential target (including a moving target cell) is referred to as a cell under test (CUT). Each CUT can be identified by the associated range bin (tap m) and associated Doppler bin (velocity k).

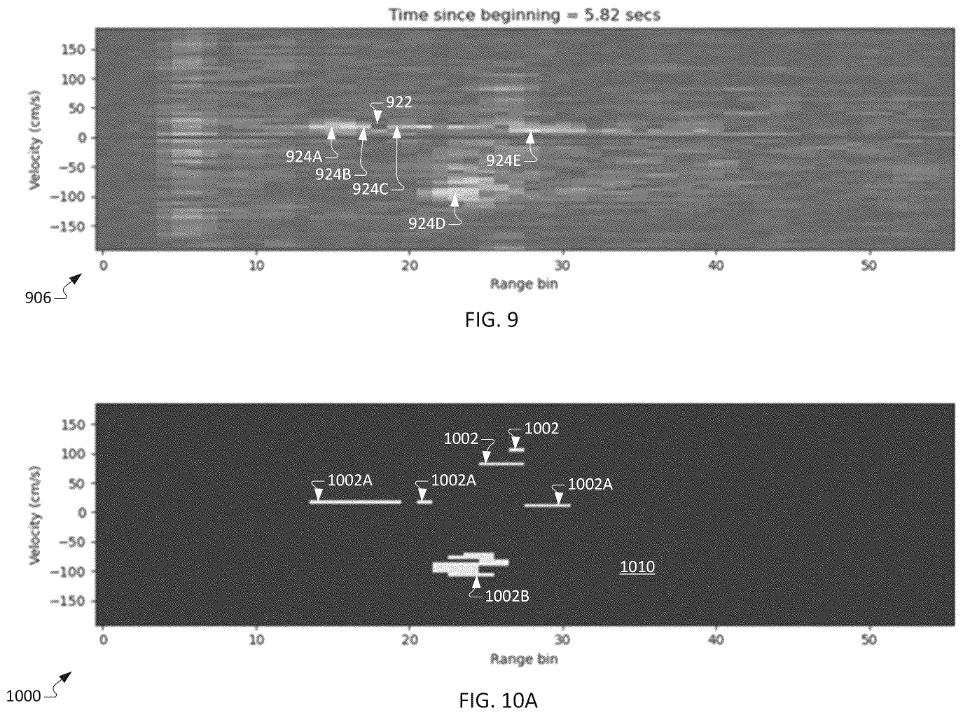

FIG. 9 illustrates an example RDM 906, in accordance with an embodiment of this disclosure. The embodiment of the RDM 906 shown in FIG. 9 is for illustration only, and other embodiments could be used without departing from the scope of this disclosure. The RDM 906 of FIG. 9 can be the same as or similar to the RDM 706 of FIG. 7 or RDM 806 of FIG. 8. In this example RDM 906 the Doppler frequency dimension is measured in units of centimeters per second (cm/s), and RDM 906 is computed from an input CIR window that starts at 5.82 seconds since the beginning of an operating session.

For each cell under test (CUT) in the RDM 906, the power level of the CUT is compared with a threshold power value to determine if the CUT belongs to a potential target. In this example, the RDM 906 contains cells with low energy level illustrated with darker shading, such as cell 922, and cells with higher energy level illustrated with brighter shading, such as cells 924A-924E.

FIG. 10A illustrates an example cell averaging constant false alarm rate (CA-CFAR) hit map 1000 generated based on the RDM 906 of FIG. 9, in accordance with an embodiment of this disclosure. The embodiment of the hit map 1000 shown in FIG. 10A is for illustration only, and other embodiments could be used without departing from the scope of this disclosure.

In the CA-CFAR detection procedure performed at block 708 of FIG. 7, for each CUT in the calculated RDM 906, the power level of the CUT is compared with a threshold to determine if it belongs to a potential target.

In the CA-CFAR detection procedure performed at block 708 of FIG. 8, an adaptive threshold is calculated for each CUT based on energy levels of neighboring cells. One example radar target detection method is Cell Averaging Constant False Alarm Rate (CA-CFAR), in which an adaptive threshold is calculated for each cell based on the energy level of neighboring cells, which provides a constant probability of a false alarm. The adaptive threshold level for a particular CUT is calculated by calculating the average power level among a block of cells around the CUT. In some embodiments, the average power level of neighboring cells is the average power level adjacent cells. These neighboring cells that are closest to the CUT are referred to as guard cells. In some embodiments, the guard cells are ignored in order to avoid power from the CUT itself corrupting the estimate of the adaptive threshold level. That is, the neighboring cells can be cells that are adjacent to the guard cells, such as a second ring out from the CUT.

Based on a determination that the energy level of the CUT itself exceeds the corresponding adaptive threshold, the HMD 700 determines that the CUT corresponds to a potential target and assigns a hit value (e.g., a binary value of one) to the CUT. A CUT is declared a hit if its power level is greater than the local average power. Based on a determination that the energy level of the CUT does not exceed the corresponding adaptive threshold, the HMD 700 determines that the CUT does not correspond to a potential target and assigns a miss value (e.g., a binary value of zero) to the CUT.

The output from CA-CFAR detection is the hit map 1000, which is a 2D map with the same size and dimensions as the RDM 906. In the hit map 1000, each cell is a hit 1002 or a miss 1010. The cells that are misses 1010 are illustrated with darker shading than the hit cells, which are illustrated with lighter shading.

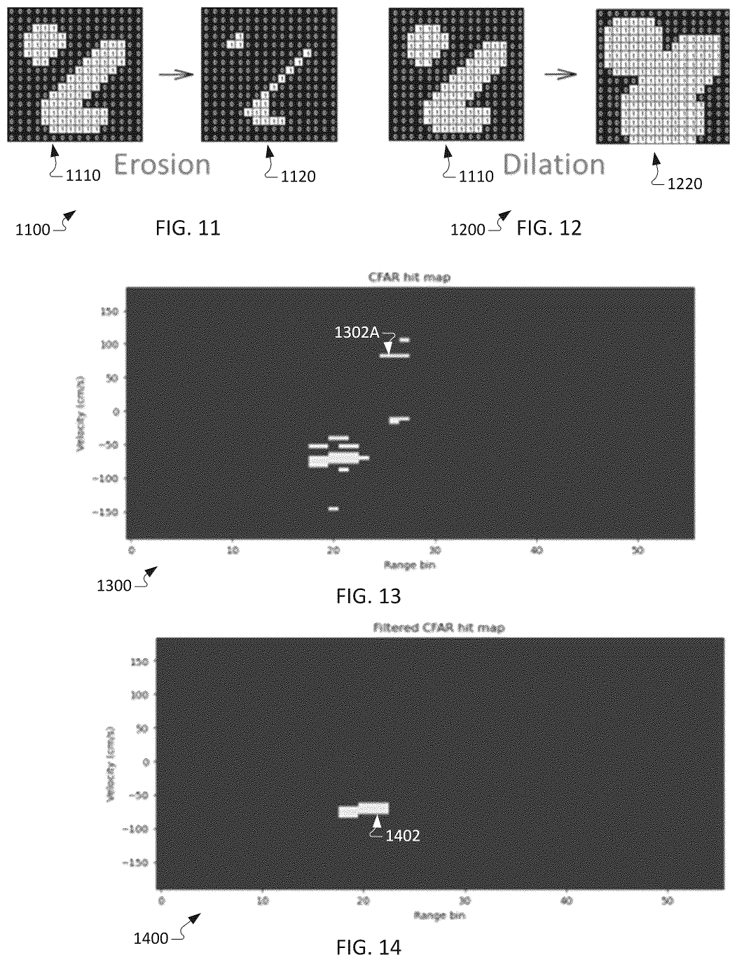

The signature on a CFAR hit map (such as the hit map 1000 of FIG. 10A) is a single line of cells 1002a for some moving objects, such as a moving fan, because of the fixed frequency of oscillation or rotation. In contrast, the signature on a CFAR hit map from human motions tend to include adjacent frequencies, so the signature of human motions on the CFAR hit map is a group 1002b of adjacent cells, both in the frequency dimension (e.g., velocity dimension) and in the range dimension. To remove the detected movements from non-human objects, the CFAR hit map can be filtered using morphological processing, which is a method used in image processing. In particular, FIGS. 11 and 12 show two morphological processing operations that are utilized in the CFAR hit map filter (for example at block 712 of FIG. 7), wherein the cells in the hit map (e.g., hit map 1000 of FIG. 10A) are treated analogous to pixels in an image.

FIGS. 10B and 10C illustrate additional features that can be extracted from the CIR window, in accordance with an embodiment of this disclosure. That is, FIGS. 9-10C illustrate features extracted from the same CIR window. FIG. 10B illustrates a graph of a range profile relative to the range bin dimension. FIG. 10C illustrates a graph of a frequency profile relative to the frequency bin dimension.

FIG. 11 illustrates an example erosion-type morphological processing 1100, in accordance with an embodiment of this disclosure. The embodiment of the erosion 1100 shown in FIG. 11 is for illustration only, and other embodiments could be used without departing from the scope of this disclosure.

Erosion shrinks an image by stripping away a layer of pixels from both the inner and outer boundaries of regions. The holes and gaps between different regions become larger, and small details are eliminated. For example, in the hit map 1110, the cells that are misses are illustrated with darker shading than the hit cells, which are illustrated with lighter shading.

For each CUT in the hit map 1110, the guard cells that are adjacent to the CUT are filtered out through the erosion 1100 such that the erosion-filtered hit map 1120 includes fewer hits than the original hit map 1110. The erosion 1100 can convert each guard cell of a particular CUT that is a hit to a miss, in some embodiments. In another embodiment, the erosion 1100 can convert each guard cell of a particular CUT that is a hit to a miss, unless the guard cell is adjacent to a hit.

FIG. 12 illustrates an example dilation-type morphological processing, in accordance with an embodiment of this disclosure. The embodiment of the dilation 1200 shown in FIG. 12 is for illustration only, and other embodiments could be used without departing from the scope of this disclosure. Dilation adds a layer of hit cells to both the inner and outer boundaries of regions.

In the embodiment shown, dilation 1200 is applied to the same the hit map 1110, which is the same as shown in FIGS. 11 and 12. The dilation 1200 of FIG. 12 is a reverse process compared to the erosion 1100 of FIG. 11. For each CUT in the hit map input to the dilation 1200, each guard cell of that particular CUT that is a miss is converted to a hit such that the dilation-filtered hit map 1220 includes more hit cells than the hit map inputted to (e.g., received into) the dilation 1200.

In other embodiments, as shown in FIGS. 13 and 14, the CFAR hit map filtering at block 712 of FIG. 7 includes applying erosion 1100 to a hit map, then subsequently applying dilation 1200 to the erosion-filtered hit map. FIG. 13 illustrates an example CA-CFAR hit map 1300 generated based on an RDM (for example, RDM 906 of FIG. 9), in accordance with an embodiment of this disclosure. FIG. 14 illustrates an example erosion-dilation filtered CA-CFAR hit map 1400 generated by processing the CA-CFAR hit map 1300 through the CFAR hit map filter at block 712 of FIG. 7. An erosion-filtered CA-CFAR hit map can be generated by applying the erosion-type morphological processing 1100 of FIG. 11 to the CA-CFAR hit map 1300 of FIG. 13. Subsequently, a dilation-filtered hit map can be generated by applying dilation-type morphological processing 1200 of FIG. 12 to the erosion-filtered CA-CFAR hit map. The embodiments of the CA-CFAR hit map 1300 and the erosion-dilation filtered hit map 1400 shown in FIGS. 13 and 14 are for illustration only, and other embodiments could be used without departing from the scope of this disclosure. The cells that are misses are illustrated with darker shading than the hit cells, which are illustrated with lighter shading.

The hit map 1300 of FIG. 13 shows the single line of cells 1302a that is the signature of the non-human movement at the fixed frequency of a fan, but this signature is filtered out or discarded from the filtered hit map 1400 of FIG. 14 by the erosion-dilation filtering. By first applying the erosion 1100 and then dilation 1200, the detected movement of non-human objects can be filtered out such that, from among the set of target cells and potential target cells, only hit cells 1402 related to human movement are kept, as shown in FIG. 14.

The filtered hit map 1400 is input to the target localization algorithm 716 of FIG. 7. From the filtered hit map 1400, the remaining hit cells 1402 related to human movement are input to a clustering algorithm, such as DBSCAN. The clustering algorithm groups adjacent cells into one group representing one target. The clustering algorithm determines a centroid for each group such that each group is then represented by the group's centroid. That is, each target is represented by the centroid for the group that represents that target. The centroid is a point with coordinates equal to the average of coordinates from all the cells in that group, in which case the coordinates are m,k coordinates according to the dimensions that are the range bin (m) and Doppler bin (k). The centroid for each group is indexed from 1 to N as the set of target objects 718 {T₁, T₂, . . . T_{N}}.

For the next step within the HMD 700, refer back to blocks 720 and 722 of FIG. 7 at which to determine if the movement surrounding each centroid is indeed human movement. To make this determination additional features are extracted from the same CIR windows 702. FIGS. 15, 16, 17, and 18 illustrate features extracted from the same CIR window, in accordance with an embodiment of this disclosure. FIG. 15 illustrates an example RDM 1500. FIG. 16 illustrates a spectrogram 1600. FIG. 17 illustrates power-weighted Doppler (PWD) 1700 and bandwidths 1750 as functions of time. FIG. 18 illustrates density 1800 as a function of time.

The HMD 700 extracts several range bins surrounding the centroid, from a start range bin ID (start_rbid)1502 to an end range bin ID (end_rbid) 1504 in the RDM 1500 of FIG. 15. The HMD 700 calculates a cir_sum value as the sum of all CIR time series from these range bins from start_rbid 1502 to end_rbid 1504.

The HMD 700 calculates a spectrogram 1600 (also referred to as spectrogram_integrated) from the cir_sum value, as shown in FIG. 16. In some embodiments, the time dimension of the spectrogram 1600 can extend the duration of the CIR window. After the spectrogram 1600 is obtained, the spectrogram 1600 can be used as input to a Machine Learning classifier that is trained to determine whether the spectrogram 1600 is from a human motion. In another embodiment, a threshold-based classifier can be used for human movement detection, namely, to determine whether the spectrogram 1600 is from a human motion.

From the spectrogram 1600, additional features can be extracted, including the PWD 1700 and bandwidth 1750 of FIG. 17. The PWD 1700 is the weighted average of the Doppler in the spectrogram 1600. The bandwidth 1750 is a measure of how widespread the Doppler is on the spectrogram. The PWD 1700 at timestep j can be calculated as shown in Equation 3. The bandwidth 1750 at timestep j can be calculated as shown in Equation 4.

$$PWD ( j ) = \frac{{Σ}_{i} f ( i ) S ( i , j )}{{Σ}_{i} S ( i , j )} \qquad ( 3 )$$

$$B ( j ) = \frac{{Σ}_{i} {( f ( i ) - PWD ( j ) )}^{2} S ( i , j )}{{Σ}_{i} S ( i , j )} \qquad ( 4 )$$

As shown in FIG. 18, the density 1800 as a function of time are features extracted from the spectrogram 1600. The density 1800 at timestep j can be calculated as shown in Equation 5, where min_freq_cell denotes the hit cell in this j-th timestep having the lowest frequency, and max_freq_cell denotes the hit cell in this j-th timestep having the highest frequency, hits denotes number of hit cells between min_freq_cell and max_freq_cell, and Total denotes the total number of cells between min_freq_cell and max_freq_cell.

$$Density ( j ) = \frac{hits}{Total} \qquad ( 5 )$$

Additional features are extracted from the RDM 1500 of FIG. 15, including the average energy Eₐᵥ corresponding to the target centroid (i_{c}, j_{c}) as measured in dB. The average energy Eₐᵥ is determined based on cells within a boundary region surrounding the target centroid. This boundary region extends from i_{c} out to a number (K) of cells in the range bin dimension, extends from j_{c} out K cells in the Doppler dimension. The average energy Eₐᵥ is an estimate of the strength of the radar signals from the target centroid. The average energy can be calculated according to Equation 6, where (i_{c}, j_{c}) denotes coordinates of the target centroid in the RDM 1500, and where the boundary region surrounding the target centroid is defined as [i_{c}−K: i_{c}+K, j_{c}−K: j_{c}+K].

$${E}_{av} = mean ( RDM [ {i}_{c} - K : {i}_{c} + K , {j}_{c} - K : {j}_{c} + K ] ) \qquad ( 6 )$$

A determination that a target centroid (i_{c}, j_{c}) represents human movement if the features corresponding to the target centroid satisfy the following three conditions, expressed as Equations 7, 8, and 9. In Equation 7, human_average_energy_db_thres denotes a distance-dependent threshold for a particular range bin ID rbid. Different range bin IDs correspond to different distance-dependent thresholds, respectively. In Equation 8, PWDs_thres denotes a threshold specified for the PWDs 1700 and is compared to the maximum absolute value of the PWDs 1700, and bws_thres denotes a threshold specified for the bandwidths 1750 and is compared to the maximum absolute value of the bandwidths 1750. In Equation 9, the window denotes a time period from a start time (illustrated as t_start) to an end time (illustrated as t_end) of the spectrogram 1600.

$${E}_{av} > human \_ average \_ energy \_ db \_ thres [ rbid ] \qquad ( 7 )$$

$$More than 10 \% of the window includes densities > 0.8 \qquad ( 8 )$$

$$OR$$

$$( max ( bandwidths ) > bws \_ thres , max ( abs ( PWDs ) ) > PWDs \_ thres ) \qquad ( 9 )$$

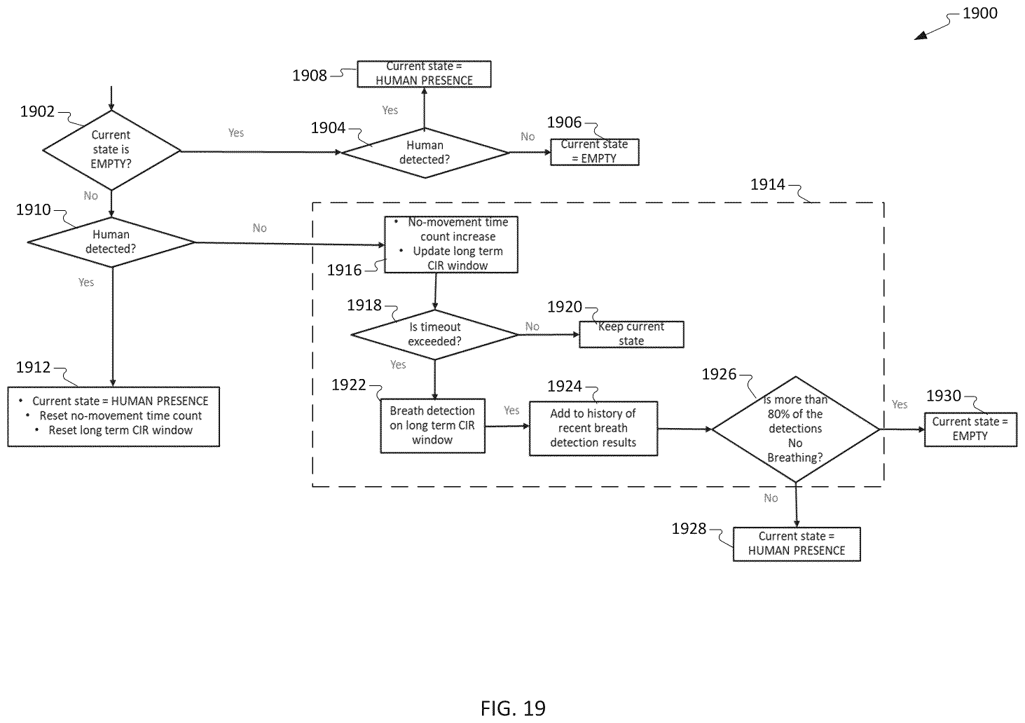

FIG. 19 illustrates an example event handlers module 1900, in accordance with an embodiment of this disclosure. The embodiment of the event handlers module 1900 shown in FIG. 19 is for illustration only, and other embodiments could be used without departing from the scope of this disclosure. The event handlers module 1900 shown in FIG. 19 is the same as the event handlers module 530 of FIG. 5 and can be simply referred to as EHM 1900.

The HMD 700 produces an output for every CIR window (702), and the time interval between outputs from the HMD 700 is much faster than the time for a human to enter a room or exit a room. The EHM 1900 can be a state machine that prevents unnecessary flickers of the human-occupation state 263 of FIG. 2, which is used for smart control of lighting, HVAC, or other home appliances. Before switching the human-occupation state 263 from the occupied state to the unoccupied state, the EHM 1900 determines the EHM 1900 detects whether a person staying still within a room, for example, a person can be sleeping on a bed or couch such that breathing motion is the only human movement detected. The EHM 1900 receives the flag human_movement_detected from the HMD 700, and updates the human-occupation state 263 of FIG. 2 based on comparing a current human-occupation state 263 to the flag human_movement_detected output from the HMD 700 and based on breath detection.

The EHM 1900 starts by identifying the current human-occupation state, for example, the value of the current human-occupation state 263 of FIG. 2. At block 1902, the EHM 1900 determines whether the current human-occupation state 263 is the unoccupied state (illustrated as EMPTY).

At block 1904, in response to a determination that the current human-occupation state 263 is the unoccupied state, the EHM 1900 determines whether to change the current human-occupation state 263 based on comparing the flag human_movement_detected (obtained from the HMD 700) to the current human-occupation state 263. If the current human-occupation state 263 and the flag human_movement_detected both indicate the unoccupied state, the EHM 1900 determines to not change the current human-occupation state 263, as shown at block 1906. If the flag human_movement_detected indicates the occupied state, which is different from the current unoccupied state (263), the EHM 1900 determines to update and change the current human-occupation state 263 to correspond to the occupied state indicated by the flag human_movement_detected, as shown at block 1908.

Alternatively, in response to a determination that the current human-occupation state 263 is the occupied state (illustrated as HUMAN PRESENCE), the EHM 1900 makes a determination at block 1906 by performing the same comparison procedure as performed at block 1904. If the current human-occupation state 263 and the flag human_movement_detected both indicate the occupied state, the EHM 1900 determines to not change the current human-occupation state 263, as shown at block 1912. At block 1912, the EHM 1900 keeps the current human-occupation state as the occupied state, resets a no-movement time count, and reset the Long Term CIR Window (e.g., 264 of FIG. 2). If the flag human_movement_detected indicates the unoccupied state, which is different from the current occupied state (263), the EHM 1900 performs breath detection at block 1914 to determine whether to change the current human-occupation state 263 to correspond to the unoccupied state indicated by the flag human_movement_detected.

The breath detection procedure of block 1914 includes blocks 1916-1926, which are described further below. If breath is detected at block 1914, the EHM 1900 determines to not change the current human-occupation state 263, and then at block 1928, in response to this determination, the EHM 1900 updates and keeps the current human-occupation state 263 as the occupied state. If breath is not detected at block 1914, the EHM 1900 determines to update and change the current human-occupation state 263 to correspond to the unoccupied state indicated by the flag human_movement_detected, and then at block 1930, in response to this determination, the EHM 1900 switches the human-occupation state 263 from the occupied state to the unoccupied state.

At block 1916, the no-movement time count is increased, and the long term CIR window (264 of FIG. 2) is updated. Even when the flag human_movement_detected indicates no human presence for the current CIR window 702, the current CIR window 702 is added or accumulated into the long-term CIR window 264 so that the current CIR window 702 can be used as part of the next step of the breath detection procedure. The room status does not immediately switch to the EMPTY state, but instead the long term CIR window 264 is repeated updated to accumulate each new CIR window 702 until a timeout period has elapsed. This timeout period is a design parameter that can be a minimum size of the long term CIR window, which is chosen to be long enough to capture a human breathing signal within the accumulated CIR data. For example, the timeout can be 20 seconds, corresponding to 20 seconds of CIR data accumulated in the long term CIR window 264.

At block 1918, if it is determined that the timeout period has not elapsed (i.e., that enough CIR data is accumulated into the long term CIR window), then the EHM 1900 keeps the current human-occupation state 263, as shown at block 1920. Alternatively, if the timeout period elapsed, then at block 1922, the EHM 1900 calls a breath detection algorithm to process the long term CIR window 264. That is, at block 1922, the long term CIR window 264 is input to and processed through the breath detection algorithm that determines whether a human breath signal is detected within the long term CIR window 264, and a breath detection result is output. The breath detection result is affirmative indicator if a human breath signal is detected, and is a negative indicator if a human breath signal is not detected.

At block 1924, the breath detection result is added to a historical register of breath detection results (e.g., breath detection results register 265 of FIG. 2). At block 1926, the EHM 1900 determines whether human presence is still detected inside the room based on, whether a threshold condition is satisfied by the count of the affirmative indicators or a count of negative indicators in the breath detection results register 265. For example, the threshold condition is not satisfied if the count of the affirmative indicators is 20% or greater of the total number of results in the breath detection results register 265. If the threshold condition is not satisfied, the EHM 1900 determines that human breath is detected sufficiently inside the room, and then the human-occupation state 263 remains unchanged at block 1928. For example, if the count of the affirmative indicators is more than 80% of the total number of results in breath detection results register 265, then the threshold condition is satisfied, the EHM 1900 determines that human breath is not detected sufficiently, and then the human-occupation state 263 changes at block 1930.

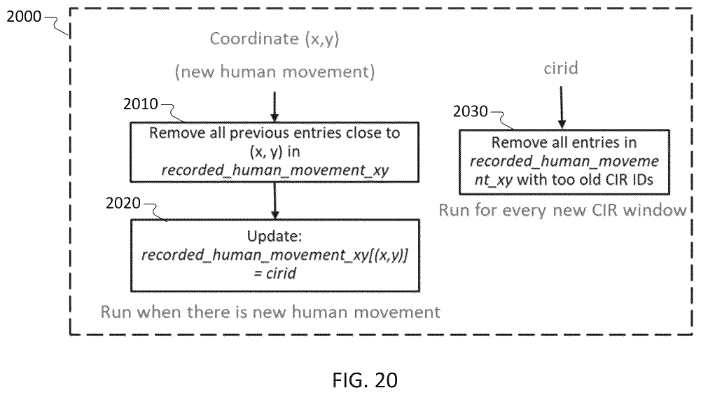

FIG. 20 illustrates an example human movement coordinates recordation module (location recorder) 2000, in accordance with an embodiment of this disclosure. The embodiment of the location recorder 2000 shown in FIG. 20 is for illustration only, and other embodiments could be used without departing from the scope of this disclosure.

To improve the accuracy of the breath signal detection module, the room-level presence detection system 500 maintains a history of recorded human movement coordinates (recorded_human_movement_xy), stored as the human movement coordinates register 266 of FIG. 2. The human movement coordinates register 266 is a map that maps a coordinate point (x,y) to the latest CIR ID of the movement at that coordinate point. This history record in the human movement coordinates register 266 is maintained by both of the following two ways: the first way is run when there is new human movement detected by the HMD 700, as shown by blocks 2010-2020; and the second way is run for every new CIR window 702 input to the HMD 700, as shown by block 2030.

In response to a new human movement detected with coordinate (x,y) and CIR ID cirid, for example, at block 750 of FIG. 7, the location recorder 2000 modifies the human movement coordinates register 266 at block 2010 by removing previously recorded entries located within a close distance proximity to the new coordinate (x,y).

At block 2020, the location recorder 2000 updates the human movement coordinates register 266 as expressed by Equation 10.

$$recorded \_ human \_ movement \_ xy [ ( x , y ) ] = cirid \qquad ( 10 )$$

At block 2030, for every new CIR window 702 (which is assigned a CIR ID), the location recorder 2000 modifies the human movement coordinates register 266 by removing entries in recorded_human_movement_xy having too old CIR IDs. In some embodiments, the removal procedure at block 2030 can be performed upon receipt of every CIR windows 702, thereby updating upon receipt of a CIR ID corresponding to non-human movement as well as upon receipt of a CIR ID cirid corresponding to the new human movement detected at coordinate (x,y). In the embodiment shown, to reduce consumption of computing resources, the removal procedure at block 2030 is triggered by the update performed block 2020, thereby updating the recorded_human_movement_xy less frequently, such as only after the new human movement is detected (750).

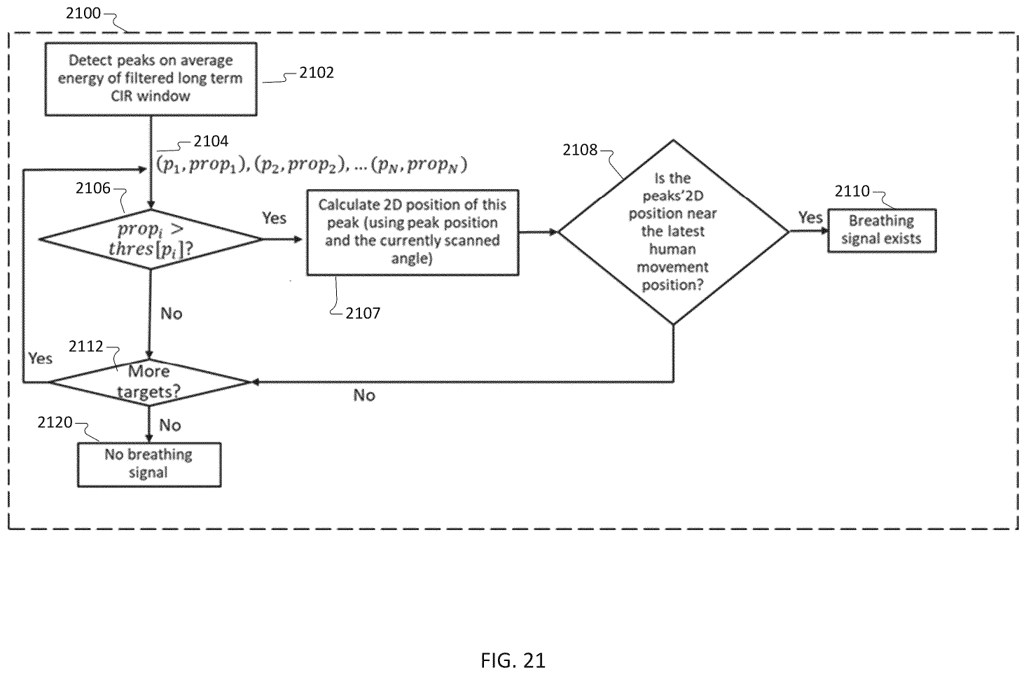

FIG. 21 illustrates an example breath detector 2100 that executes a breath detection algorithm, in accordance with an embodiment of this disclosure. The embodiment of the breath detector 2100 shown in FIG. 21 is for illustration only, and other embodiments could be used without departing from the scope of this disclosure. The breath detector 2100 of FIG. 21 is called by the EHM 1900 at block 1922 of FIG. 19. The breath detector 2100 generates, outputs, and records (into the breath detection results register 265 of FIG. 2) a breath detection result that is an affirmative indicator 2110 indicating a human breath signal is detected, or a negative indicator 2120 if a human breath signal is not detected.

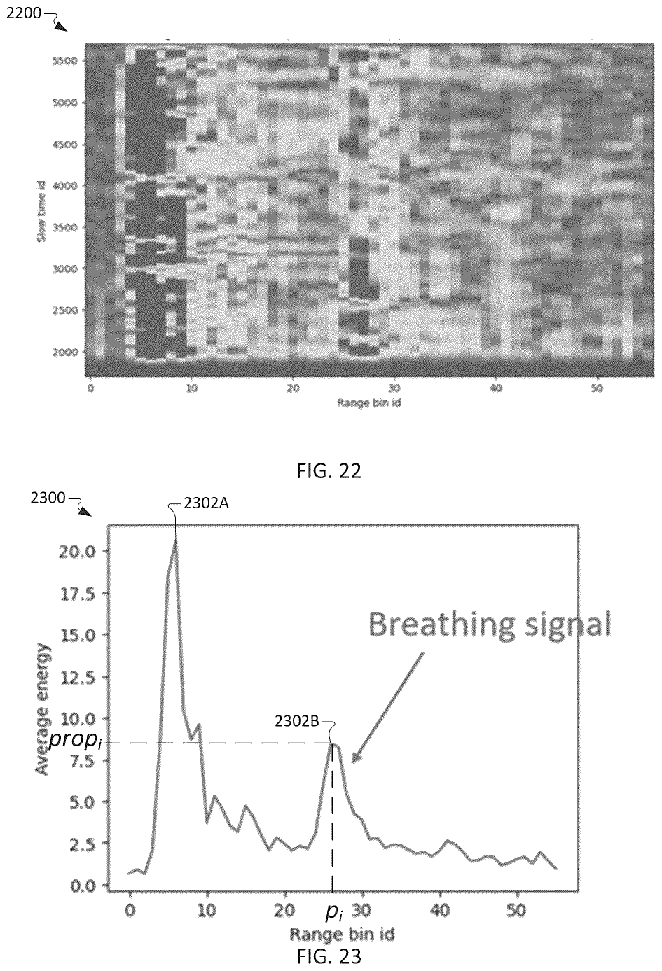

The breath detector 2100 is triggered to operate when the two long term CIR windows 702 (from two RX antennas) have accumulated sufficient samples (e.g., 20 seconds). Before block 2102, the breath detector 2100 can perform some preprocessing to obtain the extracted features shown in FIGS. 22-23. FIGS. 21, 22, and 23 are described together, as the breath detector 2100 of FIG. 21 analyzes the CIRSUM 2200 and graph 2300 of FIG. 23. FIG. 22 illustrates an example CIRSUM 2200 after clutter removal and low pass filtering is applied, in accordance with an embodiment of this disclosure. FIG. 23 illustrates an example graph 2300 of average energy per range bin, in accordance with an embodiment of this disclosure. The embodiments of the CIRSUM 2200 and graph 2300 shown in FIGS. 22-23 are for illustration only, and other embodiments could be used without departing from the scope of this disclosure.

Referring to FIG. 22, for each angle of arrival θ, a cirsum value is calculated according to Equation 11. In effect, the cirsum value is calculated to combine signals received at the two RX antennas of the UWB radar module with a steering vector to each angle of arrival. Such combination boosts (e.g., increases the magnitude of) the signal received at the radar, thus small movements such as breathing movements are able to be detected at longer distances (4-5 meters) from the radar compared to a case in which the radar received signals from only one RX antenna (i.e., breathing can only be detected up to 2 meters away).

$$cirsum = longtermcir 1 + {e}^{- j 2 π dsin ( θ )} * longtermcir 2 \qquad ( 11 )$$

The CIRSUM 2200 for each angle of arrival θ is analyzed to determine whether a breathing signal exists. To obtain the CIRSUM 2200, the cirsum value is first processed through a clutter removal process and a low pass filter (e.g., with cutoff frequency=1 Hz) to remove frequency components outside of the breathing signal frequency range (e.g., 0.1 Hz to 1 Hz). Then, the average energy per range bin (e.g., graph 2300 of FIG. 23) is calculated based on the CIRSUM 2200.

Referring to FIG. 21, at block 2102, breath detector 2100 detects peaks 2303a-2302b on the average energy of a filtered long term CIR window, as shown in FIG. 23. More particularly, breath detector 2100 detects a set of peaks 2104 (namely, the peaks 2303a-2302b of FIG. 23) on the array of average energy per range bin together with their associated prominence values {illustrated as (p₁, prop₁) (p₂, prop₂) . . . (p_{N}, prop_{N})}. These peaks {(p₁, prop₁) (p₂, prop₂) . . . (p_{N}, prop_{N})} are analyzed one by one until a peak is determine to satisfy a group of conditions defining a human breath signal, such as following group of two conditions at blocks 2106 and 2108. The prominence value associated with a peak can be a measure of how much greater the average energy of the peak is compared to the average energy of neighboring range bins.

The condition at block 2106 is satisfied if the peak prominence is greater than a range-dependent threshold, as expressed according to Equation 12, where propᵢ denotes the prominence value associated with the range bin position pᵢ (also referred to as “range bin ID” or simply “range bin”), and i denotes the index from 1 to the total number of peaks in the set of peaks 2104. The 2D position of the peak 2302b can be the corresponding range bin ID pᵢ obtained from the graph 2300 of average energy per range bin of FIG. 23, and the associated the prominence value propᵢ can be the average energy.

$${prop}_{i} > thres [ {p}_{i} ] \qquad ( 12 )$$

At block 2107, the peak's 2D position is calculated from the peak's range bin pᵢ and the currently scanned angle of arrival θ (which is mapped to the CIRSUM 2200 of FIG. 22). The condition at block 2108 is satisfied if the 2D position of the peak is near (such as within a distance threshold) the position of the latest human movement. More particularly, condition at block 2108 is satisfied if the 2D position of the peak is near the item in the above mentioned recorded_human_movement_xy with the latest CIR ID. The criteria for closeness can be that the Euclidean distance between the peak's 2D position and the latest human movement position is less than a distance threshold (e.g., 0.5 m).

In another embodiment, the Doppler information of the movements can be recorded for identifying the entrance/exit point or the location where the human often sits/sleeps. Such Doppler information could help improve the reliability and reduce the search space for the breath detector 2100.

At block 2110, when such a peak is determined to satisfy both conditions at blocks 2106 and 2108, a breathing signal is determined to exist in the current long term CIR windows 264. If any among the conditions at blocks 2106 and 2108 is not satisfied by a peak, then at block 2112, the breath detector 2100 determines whether any the set of peaks 2104 includes a peak that has not yet been analyzed through blocks 2106 and 2108. If the entire set of peaks 2104 fail to satisfy both conditions at blocks 2106 and 2108, then at block 2120, it is determined that a breathing signal does not exist in the current long term CIR windows 264.

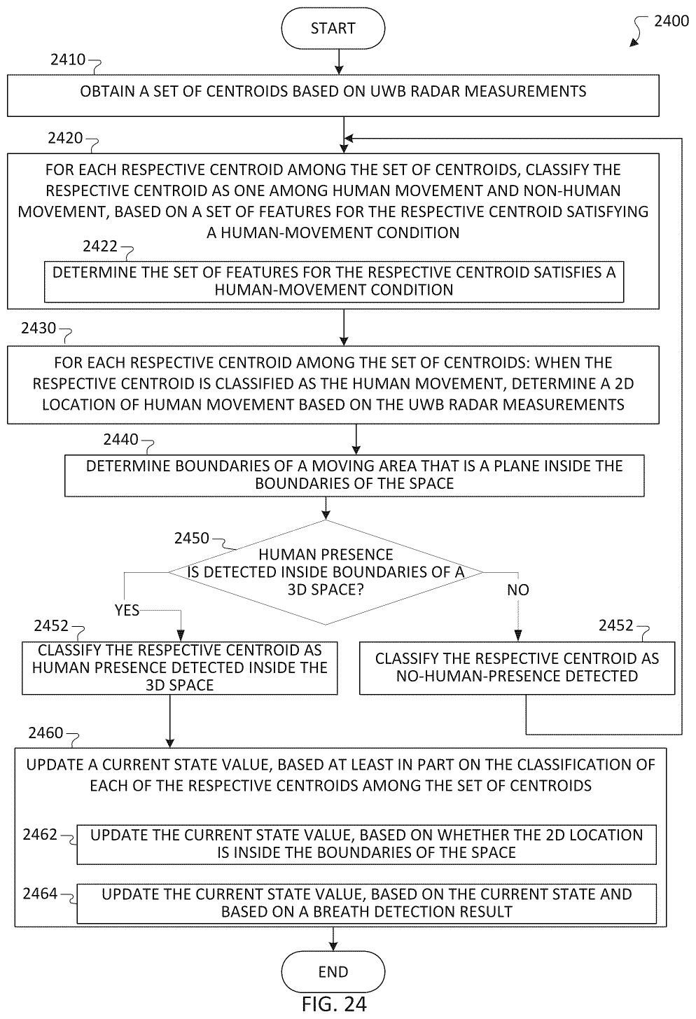

FIG. 24 illustrates a method 2400 for presence detection using UWB radar, in accordance with an embodiment of this disclosure. The embodiment of the method 2400 shown in FIG. 24 is for illustration only, and other embodiments could be used without departing from the scope of this disclosure. The method 2400 is implemented by an electronic device 200 having a transceiver configured to transmit and receive UWB radar signals. For ease of explanation, the method 2400 is described as being performed by the processor 240 executing the room-level presence detection system 500 of FIG. 5, which incorporates components from FIGS. 7, 19, 20, and 21.

At block 2410, the processor 240 obtains a set of centroids based on ultra-wide band (UWB) radar measurements. For example, the processor 240 uses the HMD 700 to generate the set of targets 718 based on the CIR windows 702, as shown in FIG. 7.

In some embodiments of block 2410, to obtain the set of centroids based on UWB radar measurements, the processor 240 calculates a range doppler map (RDM) based on the UWB radar measurements. Examples of the RDM include RDMs 806, 906, and 1500 of FIGS. 8, 9 and 15. For each cell under test (CUT) in the RDM, the processor 240 procedures similar to the procedure of blocks 708-716 of FIG. 7. That is, for each CUT, the processor 240 calculates an adaptive threshold power level for the CUT based on an energy level of neighboring cells of the CUT; determines whether a power level for the CUT exceeds the adaptive threshold power level; and determines that the CUT corresponds to a potential target based on the power level for the CUT that exceeds the adaptive threshold power level. The processor 240 generates a CA-CFAR hit map that includes a hit cell mapped to each CUT in the RDM that corresponds to the potential target. The processor 240 applies a clustering algorithm to the filtered CA-CFAR hit map. A centroid of each respective cluster of adjacent cells represents the cluster. Each respective cluster represents a respective target, such as the target 408 of FIG. 4.

At block 2420, for each respective centroid among the set of centroids, the processor 240 classifies the respective centroid as one among human movement and non-human movement, based on a set of features for the respective centroid satisfying a human-movement condition. To classify the respective centroid as human movement, at block 2422, the processor 240 determines whether the set of features for the respective centroid satisfy a human-movement condition.

At block 2430, for each respective centroid among the set of centroids, when the respective centroid is classified as the human movement, the processor 240 determines a two-dimensional (2D) location of human movement based on the UWB radar measurements.

At block 2440, to the processor 240 determines boundaries of a moving area that is a plane inside the boundaries of a space. The 2D location of the human movement is in the plane. The UWB radar measurements are generated by at least two antennas that are next to each other and at least one of parallel to or coplanar with the plane.

At block 2450, the processor 240 determines whether human presence is detected inside the boundaries of the 3D space. At block 2452, in response to a determination that human presence is not detected inside the boundaries of the 3D space, the processor 240 classifies the respective centroid as no-human-presence detected, and the method 2400 returns to block 2420. The procedure at block 2452 is similar to the procedure at block 760 of FIG. 7. At block 2454, in response to a determination that human presence is detected inside the boundaries of the 3D space, the processor 240 classifies the respective centroid as human-presence detected, and the method 2400 proceeds to block 2460. The procedure at block 2454 is similar to the procedure at block 750 of FIG. 7.

In some embodiments, in response to a determination the 2D location of human movement is inside boundaries of a moving area inside the space, the processor 240 maps a latest channel impulse response (CIR) identifier (ID) to coordinates of the 2D location of human movement, records the latest CIR ID in a CIR window of time, and when a new 2D location of human movement is determined, the processor 240 updates the CIR window of time by recording a new CIR ID mapped to coordinates of the new 2D location of human movement. In such embodiments, the CIR window includes a series of CIR IDs.

At block 2460, the processor 240 updates a current state value that indicates whether a human presence is detected inside boundaries of a 3D space, based at least in part on the classification of each of the respective centroids among the set of centroids. In some embodiments, updating the current state value further comprises updating, based on whether the 2D location is inside the boundaries of the space, as shown at block 2462. In some embodiments, updating the current state value further comprises updating, based on the current human-occupation state 263 and based on a breath detection result, as shown at block 2464.

At block 2462, it has been determined that the current state value represents a current state of human presence inside the boundaries of the space. At block #62, the processor 240 updates the current state value to one of: a first current state value that represents human presence is detected inside boundaries of a space such that the current state is not-EMPTY, or a second current state value that represents human presence is not detected inside boundaries of a space such that the current state is EMPTY.

At block 2464, in response to a determination that a respective centroid among the set of centroids is classified a human movement and that the current human-occupation state 263 is not-EMPTY, the processor 240 resets a no-movement time count, and resets a channel impulse response (CIR) window of time that is defined by a sliding window of a series of CIR inputs. The procedure at block 2464 is similar to the procedure of block 1912 of FIG. 19.

In some cases, the current human-occupation state 263 is not-EMPTY, and the HMD 700 subsequently determines that none of the respective centroids among the set of centroids is classified as human movement, such as at block 1916 of FIG. 19. For each new CIR 702 received prior to expiry of a timeout period (e.g., block 1918), the processor 240 increments a no-movement time count, updates a long term CIR window 264 of time by adding the new CIR 702, and does not change the current human-occupation state, as shown at block 1920. After the timeout period expires, the processor 240 performs a breath detection algorithm to determine whether a breath signal is detected within a proximity distance to a latest 2D location of human movement. The processor 240 executes breathing detection algorithm shown in FIG. 21, which is called or triggered by the EHM 1900 at block 1922.

As part of executing the breathing detection algorithm 2100, the processor 240 detects peaks of average energy based on historical UWB radar measurements corresponding to the CIR window, for example as shown at block 2102. The processor 240 determines whether the breath signal is detected based on whether a prominence of each of the peaks satisfies a threshold prominence condition, for example as shown at block 2106. The processor 240 calculates a 2D location of breathing corresponding to each peak 2302a-2302b that satisfied the threshold prominence condition, for example as shown at block 2107. The processor 240 determines that the breathing signal is detected based on a determination that the 2D location of breathing is within a proximity distance to the latest 2D location of the human movement, for example as shown at block 2108. In response to a determination that the breathing signal is detected, the processor 240 adds an affirmative indicator into a historical register of breath detection results, for example as shown at block 2110. On the other hand, in response to a determination that the breathing signal is not detected, the processor 240 adds a negative indicator into the historical register of breath detection results, for example as shown at block 2120. The processor 240 determines whether the human presence is detected inside the boundaries of the 3D space based on a count of the affirmative indicators in the historical register of breath detection results, for example as shown at block 1926.

Although FIG. 24 illustrates an example method 2400 for presence detection using UWB radar, various changes may be made to FIG. 24. For example, while shown as a series of steps, various steps in FIG. 24 could overlap, occur in parallel, occur in a different order, or occur any number of times.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
obtaining a set of centroids based on ultra-wide band (UWB) radar measurements;
for each respective centroid among the set of centroids:
classifying the respective centroid as one among human movement and non-human movement, based on a set of features for the respective centroid satisfying a human-movement condition; and
when the respective centroid is classified as the human movement, determining a two-dimensional (2D) location of human movement based on the UWB radar measurements; and
updating a current state value that indicates whether a human presence is detected inside boundaries of a 3D space, based at least in part on the classification of each of the respective centroids among the set of centroids.

2. The method of claim 1, further comprising:
determining boundaries of a moving area that is a plane inside the boundaries of the space,
wherein:
the 2D location of the human movement is in the plane; and
the UWB radar measurements are generated by at least two antennas that are next to each other and at least one of parallel to or coplanar with the plane.

3. The method of claim 1, wherein:
the current state value represents a current state of human presence inside the boundaries of the space; and
updating the current state value further comprises updating, based on whether the 2D location is inside the boundaries of the space, the current state value to one of:
a first current state value that represents human presence is detected inside boundaries of a space such that the current state is not-EMPTY, or
a second current state value that represents human presence is not detected inside boundaries of a space such that the current state is EMPTY.

4. The method of claim 3, further comprising in response to a determination that a respective centroid among the set of centroids is classified a human movement and that the current state is not-EMPTY:
resetting a no-movement time count, and
resetting a channel impulse response (CIR) window of time that is defined by a sliding window of a series of CIR inputs.

5. The method of claim 1, further comprising:
in response to a determination the 2D location of human movement is inside boundaries of a moving area inside the space, mapping a latest channel impulse response (CIR) identifier (ID) to coordinates of the 2D location of human movement;
recording the latest CIR ID in a CIR window of time; and
when a new 2D location of human movement is determined, updating the CIR window of time by recording a new CIR ID mapped to coordinates of the new 2D location of human movement,
wherein the CIR window includes a series of CIR IDs.

6. The method of claim 1, further comprising in response to a determination that none of the respective centroids among the set of centroids is classified as human movement:
for each new CIR prior to expiry of a timeout period:
incrementing a no-movement time count,
updating a channel impulse response (CIR) window of time by adding the new CIR, and
not changing the current state; and
after the timeout period expires, performing a breath detection algorithm to determine whether a breath signal is detected within a proximity distance to a latest 2D location of human movement.

7. The method of claim 6, wherein performing the breath detection algorithm comprises:
detecting peaks of average energy based on historical UWB radar measurements corresponding to the CIR window;
determining whether the breath signal is detected based on whether a prominence of each of the peaks satisfies a threshold prominence condition;
calculating a 2D location of breathing corresponding to each peak that satisfied the threshold prominence condition; and
determining that the breathing signal is detected based on a determination that the 2D location of breathing is within a proximity distance to the latest 2D location of the human movement.

8. The method of claim 6, further comprising:
in response to a determination that the breathing signal is detected, adding an affirmative indicator into a historical register of breath detection results;
in response to a determination that the breathing signal is not detected, adding a negative indicator into the historical register of breath detection results; and
determining whether the human presence is detected inside the boundaries of the 3D space based on a count of the affirmative indicators in the historical register of breath detection results.

9. The method of claim 8, further comprising:
determining that the human presence is detected inside the boundaries of the 3D space based on the count of the affirmative indicators in the historical register of breath detection results exceeding a threshold.

10. The method of claim 1, wherein obtaining the set of centroids further comprises:
calculating a range doppler map (RDM) based on the UWB radar measurements;
for each cell under test (CUT) in the RDM:
calculating an adaptive threshold power level for the CUT based on an energy level of neighboring cells of the CUT; and
determining that the CUT corresponds to a potential target based on a power level for the CUT that exceeds the adaptive threshold power level; and
generating a cell averaging constant false alarm rate (CA-CFAR) hit map that includes a hit cell mapped to each CUT in the RDM that corresponds to the potential target;
filtering the CA-CFAR hit map applying an erosion and a dilation of morphological processing; and
applying a clustering algorithm to the filtered CA-CFAR hit map, wherein a centroid of each respective cluster of adjacent cells represents the cluster, and wherein each respective cluster represents a respective target.

11. An electronic device comprising:
a transceiver configured to transmit and receive radar signals; and
a processor operably connected to the transceiver and configured to:
obtain a set of centroids based on ultra-wide band (UWB) radar measurements;
for each respective centroid among the set of centroids:
classify the respective centroid as one among human movement and non-human movement, based on a set of features for the respective centroid satisfying a human-movement condition; and
when the respective centroid is classified as the human movement, determine a two-dimensional (2D) location of human movement based on the UWB radar measurements; and
update a current state value that indicates whether a human presence is detected inside boundaries of a 3D space, based at least in part on the classification of each of the respective centroids among the set of centroids.

12. The electronic device of claim 11, wherein the processor is further configured to:
determine boundaries of a moving area that is a plane inside the boundaries of the space,
wherein:
the 2D location of the human movement is in the plane; and
the UWB radar measurements are generated by at least two antennas that are next to each other and at least one of parallel to or coplanar with the plane.

13. The electronic device of claim 11, wherein:
the current state value represents a current state of human presence inside the boundaries of the space; and
to update the current state value, the processor is further configured to update, based on whether the 2D location is inside the boundaries of the space, the current state value to one of:
a first current state value that represents human presence is detected inside boundaries of a space such that the current state is not-EMPTY, or
a second current state value that represents human presence is not detected inside boundaries of a space such that the current state is EMPTY.

14. The electronic device of claim 13, wherein the processor is further configured to in response to a determination that a respective centroid among the set of centroids is classified a human movement and that the current state is not-EMPTY:
reset a no-movement time count, and
reset a channel impulse response (CIR) window of time that is defined by a sliding window of a series of CIR inputs.

15. The electronic device of claim 11, wherein the processor is further configured to:
in response to a determination the 2D location of human movement is inside boundaries of a moving area inside the space, map a latest channel impulse response (CIR) identifier (ID) to coordinates of the 2D location of human movement;
record the latest CIR ID in a CIR window of time; and
when a new 2D location of human movement is determined, update the CIR window of time by recording a new CIR ID mapped to coordinates of the new 2D location of human movement,
wherein the CIR window includes a series of CIR IDs.

16. The electronic device of claim 11, wherein the processor is further configured to in response to a determination that none of the respective centroids among the set of centroids is classified as human movement:
for each new CIR prior to expiry of a timeout period:
increment a no-movement time count,
update a channel impulse response (CIR) window of time by adding the new CIR, and
not change the current state; and
after the timeout period expires, perform a breath detection algorithm to determine whether a breath signal is detected within a proximity distance to a latest 2D location of human movement.

17. The electronic device of claim 16, wherein to perform the breath detection algorithm, the processor is further configured to:
detect peaks of average energy based on historical UWB radar measurements corresponding to the CIR window;
determine whether the breath signal is detected based on whether a prominence of each of the peaks satisfies a threshold prominence condition;
calculate a 2D location of breathing corresponding to each peak that satisfied the threshold prominence condition; and
determine that the breathing signal is detected based on a determination that the 2D location of breathing is within a proximity distance to the latest 2D location of the human movement.

18. The electronic device of claim 16, wherein the processor is further configured to:
in response to a determination that the breathing signal is detected, add an affirmative indicator into a historical register of breath detection results;
in response to a determination that the breathing signal is not detected, add a negative indicator into the historical register of breath detection results; and
determine whether the human presence is detected inside the boundaries of the 3D space based on a count of the affirmative indicators in the historical register of breath detection results.

19. The electronic device of claim 18, wherein the processor is further configured to:
determine that the human presence is detected inside the boundaries of the 3D space based on the count of the affirmative indicators in the historical register of breath detection results exceeding a threshold.

20. The electronic device of claim 11, wherein to obtain the set of centroids, the processor is further configured to:
calculate a range doppler map (RDM) based on the UWB radar measurements;
for each cell under test (CUT) in the RDM:
calculate an adaptive threshold power level for the CUT based on an energy level of neighboring cells of the CUT; and
determine that the CUT corresponds to a potential target based on a power level for the CUT that exceeds the adaptive threshold power level; and
generate a cell averaging constant false alarm rate (CA-CFAR) hit map that includes a hit cell mapped to each CUT in the RDM that corresponds to the potential target;
filter the CA-CFAR hit map applying an erosion and a dilation of morphological processing; and
apply a clustering algorithm to the filtered CA-CFAR hit map, wherein a centroid of each respective cluster of adjacent cells represents the cluster, and wherein each respective cluster represents a respective target.
